(19) United States
(12) Patent Application Publication
(10) Pub. No.: US 2002/0118414 A1
(43) Pub. Date: Aug. 29, 2002

(54) Wavelength division multiplexing ring network system, optical path setting method, recovery method, and program

(75) Inventors: Yoshinori Yuki, Fuchu-shi (JP); Hiroyuki Ibe, Yokohama-shi (JP)

Correspondence Address: Finnegan, Henderson, Farabow,, Garrett & Dunner, L.L.P., 1300 I Street, N.W., Washington, DC, 20005-3315, US

(73) Assignee: KABUSHIKI KAISHA TOSHIBA

(21) Appl. No.: 10/079,497

(22) Filed: Feb. 22, 2002

(30) Foreign Application Priority Data
Feb. 23, 2001 (JP) 2001-048492

(51) Int. Cl. H04B 10/20; H04J 14/00; H04J 14/02

(52) U.S. Cl. 359/119; 359/124

(57) ABSTRACT

An optical path setting method sets a two-way current optical path on the same route between two nodes, and sets a two-way spare optical path on a route reverse to the current optical path. The optical path accommodation efficiency is increased by sharing one spare optical path among a plurality of current optical paths having different routes. When a trouble occurs, a current optical path is switched to a spare optical path in a signaling-less manner at high speed.

### CROSS-REFERENCE TO RELATED APPLICATIONS

This application is based upon and claims the benefit of priority from the prior Japanese Patent Application No. 2001-048492 filed Feb. 23, 2001, the entire contents of which are incorporated herein by reference.

### BACKGROUND OF THE INVENTION

1. Field of the Invention

The present invention relates to a path accommodating method and recovery method of a communication network and, more particularly, to an optical path accommodating method and recovery method of a wavelength division multiplexing ring network.

2. Description of the Related Art

With the advance of optical communication technologies, the transmission capacity of communication by a single optical transmission line has greatly increased. In particular, a wavelength division multiplexing network using WDM (Wavelength Division Multiplexing) capable of transmitting optical signals wavelength-by-wavelength can transmit a large-capacity optical signal at high speed. In this WDM network, optical paths are set between nodes which constitute the network by using wavelengths. This allows flexible allocation of transmission capacities corresponding to communication demands.

As methods of setting optical paths in the WDM network, a method of allocating one wavelength between terminal nodes of an optical path and a method of allocating a plurality of wavelengths, where necessary, by wavelength conversion at relay nodes have been proposed (e.g., Imrich Chlamtac et al., “Lightpath Communications: An Approach to High Bandwidth Optical WAN's, IEEE Transaction on Communications, Vol. 40, No. 7, July 1992). In a WDM ring network system in which nodes are connected by optical transmission lines so as to form a ring-like topology, the system performance presumably changes significantly in accordance with which of the above two methods is used. For example, to accommodate optical paths as many as possible without changing an optical path currently being operated, it is reportedly desirable to use the latter method having a wavelength conversion function (e.g., Yuki, Nakao, and Ibe, “Examination on Wavelength Path Setting Method in WDM Network”, 2000 IEICE Society Conference, B-10-123, October 2000).

In a WDM ring network system, demand has arisen for implementing various services (dispersion of the network load by traffic engineering and construction of an optical VPN (Virtual Private Network)) using optical paths, and so it is becoming necessary to dynamically set optical paths while the system is in operation. In this case, to improve the system reliability by preparing for breakage of optical transmission lines connecting nodes and for node troubles, a spare optical path is allocated on a route reverse to a current optical path allocated between two given nodes. When a trouble occurs, recovery is performed by using the spare optical path so that communication between the two nodes continues. To implement an economical, highly reliable WDM ring network system, therefore, it is essential to increase the optical path accommodation efficiency and thereby rapidly switch from a current optical path to a spare optical path when a trouble occurs.

FIG. 1 shows an example in which optical paths are allocated on the basis of the conventional technique in a WDM ring network system in which five nodes Aa through Ee are connected into the form of a ring by optical transmission lines. Referring to FIG. 1, a current optical path is indicated by the solid line, and a spare optical path is indicated by the broken line. In this example, the two-way current optical path is allocated by using the node Cc as a relay node and the nodes Bb and Dd as terminal nodes. The spare optical path is allocated on a route reverse to the current optical path by using the nodes Aa and Ee as relay nodes. Therefore, assuming the number of wavelengths of a one-way (clockwise or counterclockwise) ring is n in this conventional WDM ring network system, if a two-way current optical path passing through the same route is allocated between two nodes and a two-way spare optical path is allocated on a route reverse to this current optical path in one-to-one correspondence with the current optical path, a maximum of only n optical paths (one optical path is composed of one current optical path and one spare optical path) can be set. This lowers the optical path setting efficiency. Accordingly, the number of wavelengths must be increased to increase the number of optical paths to be accommodated. This makes it difficult to construct an economical WDM ring network system.

For example, Jpn. Pat. Appln. KOKAI Publication No. 11-163911 describes a method of increasing the optical path accommodation efficiency when an optical path is allocated using one wavelength between terminal nodes of this optical path. However, no practical countermeasure has been proposed by which the optical path accommodation efficiency is increased in a WDM ring network system, having a wavelength conversion function, to be used most frequently in the future. In addition, as an operation of switching a current optical path to a spare optical path when a trouble occurs, Jpn. Pat. Appln. KOKAI Publication No. 11-163911 describes a method of notifying a message between terminal nodes of an optical path including a relay node. In this method, however, the message must be relayed by all nodes on the route of a spare optical path. Accordingly, if the system is upscaled by increasing the number of nodes or the number of wavelengths, the processing load of message transfer may increase, by switching from a current optical path to a spare optical path, at a node having no relation to a trouble. Also, this may prolong the time required for recovery.

### BRIEF SUMMARY OF THE INVENTION

It is an object of the present invention to provide a WDM ring network system having a wavelength conversion function, in which the optical path accommodation efficiency is increased and a recovery operation when a trouble occurs is simplified and made fast, and which is economical and highly reliable even when the system is upscaled by increasing the number of nodes or wavelengths, and to provide an optical path setting method, recovery method, and program for the system.

To solve the above problems and achieve the object, a wavelength division multiplexing ring network system according to the present invention which comprises an optical transmission line including at least a clockwise optical transmission line and a counterclockwise optical transmission line, and a plurality of nodes connected into the form of a ring via the transmission line to transmit and receive a plurality of optical signals having different wavelengths, terminate optical paths, and switch connections of the optical paths, and in which an optical path having an arbitrary wavelength is set by which an optical signal transmitted from an arbitrary start node through an arbitrary optical fiber is received by an arbitrary end node, is characterized by comprising

means for setting a current optical path on a route via the clockwise or counterclockwise optical transmission line extending from the start node to the end node, and setting a spare optical path on a route reverse to the current optical path extending from the start node to the end node, and

means for sharing the spare optical path among the current optical paths having different routes.

In the above invention, a spare optical path is shared by current optical paths having different routes, so the number of wavelengths necessary to form a spare optical path is decreased. Accordingly, the number of optical paths capable of being accommodated can be increased.

Also, the present invention is characterized by further comprising means for setting the current optical path between nodes by a shortest route.

In the above invention, a current optical path is allocated by the shortest route between nodes, so the route of a spare optical path becomes longer than that of a current optical path. Since this increases the degree of sharing of a spare optical path, the number of optical paths capable of being accommodated can be increased.

Furthermore, the present invention is characterized by further comprising means for setting the current optical path and the spare optical path in two ways between nodes.

In the above invention, a current optical path and a spare optical path are allocated in two ways, so the route of a spare optical path becomes longer than that of a current optical path. Since this increases the degree of sharing of a spare optical path, the number of optical paths capable of being accommodated can be increased.

According to the present invention, a wavelength division multiplexing ring network system which comprises an optical transmission line including at least a clockwise optical transmission line and a counterclockwise optical transmission line, and a plurality of nodes connected into the form of a ring via the transmission line to transmit and receive a plurality of optical signals having different wavelengths, terminate optical paths, and switch connections of the optical paths, and in which an optical path having an arbitrary wavelength is set by which an optical signal transmitted from an arbitrary start node through an arbitrary optical fiber is received by an arbitrary end node, is characterized by comprising

means for setting a current optical path on a route via the clockwise or counterclockwise optical transmission line extending from the start node to the end node, and setting a spare optical path on a route reverse to the current optical path extending from the start node to the end node,

means for sharing the spare optical path among the current optical paths having different routes, and, when a node which terminates the current optical path detects a trouble pertaining to reception of an optical signal, outputting an optical signal to both the current optical path and the spare optical path, sending an alarm signal to an opposite node of the current optical path having the trouble, and switching inputting of optical signals to the spare optical path, and

means for, when a node which terminates the current optical path detects the alarm signal, outputting an optical signal to both the current optical path and the spare optical path, and switching inputting of optical signals to the spare optical path.

In the above invention, as node operations when a trouble occurs in a current optical path, (1) optical signals are output to both the current optical path and a spare optical path, (2) an alarm signal is sent, and (3) inputting of optical signals is switched to the spare optical path. Also, as node operations when an alarm signal is detected, (1) optical signals are output to both a current optical path and a spare optical path, and (2) inputting of optical signals is switched to the spare optical path. Therefore, no messages need be notified between terminal nodes of an optical path when a trouble occurs, so recovery from the trouble can be performed by an extremely simple operation.

According to the present invention, a wavelength division multiplexing ring network system which comprises a plurality of nodes for transmitting and receiving a plurality of optical signals having different wavelengths, terminating optical paths, and switching connections of the optical paths, and a network manager connected to at least one node, and in which the nodes are connected into the form of a ring via at least a clockwise optical transmission line and a counterclockwise optical transmission line, and an optical path having an arbitrary wavelength is set by which an optical signal transmitted from an arbitrary start node through an arbitrary optical fiber is received by an arbitrary end node, is characterized by comprising

means for setting a current optical path on a route via the clockwise or counterclockwise optical transmission line extending from the start node to the end node, and setting a spare optical path on a route reverse to the current optical path extending from the start node to the end node,

the network manager including optical path requesting means for requesting at least one node forming an optical path to set an optical path,

the node including optical path setting means for setting an optical path between nodes forming an optical path on the basis of the request from the network manager,

the optical path requesting means including means for checking whether an optical path can be set, means for determining a node to be requested to set an optical path, and means for checking whether the spare optical path can be shared,

the optical path setting means including means for setting an insertion wavelength of an optical path, means for setting a conversion wavelength of an optical path, and means for setting a branching wavelength of an optical path,

the means for checking whether the spare optical path can be shared including means for determining that the spare optical path can be shared when routes of the current optical paths set between nodes do not overlap, and requesting at least one node to set an optical path so as to form a new spare optical path by sharing an existing spare optical path, and

the optical path setting means including means for forming a new spare optical path by sharing a wavelength used by an existing spare optical path, when requested by the network manager to form the new spare optical path by sharing the existing spare optical path.

In the above invention, the optical path requesting means comprises the means for checking whether a spare optical path can be shared, and the optical path setting means comprises the means for forming a spare optical path by sharing the wavelength. Since a spare optical path can be shared by current optical paths having different routes, the number of wavelengths necessary to form a spare optical path can be reduced. This makes it possible to increase the number of optical paths capable of being accommodated.

According to the present invention, a wavelength division multiplexing ring network system which comprises an optical transmission line including at least a clockwise optical transmission line and a counterclockwise optical transmission line, and a plurality of nodes connected into the form of a ring via the transmission line to transmit and receive a plurality of optical signals having different wavelengths, terminate optical paths, and switch connections of the optical paths, and in which an optical path having an arbitrary wavelength is set by which an optical signal transmitted from an arbitrary start node through an arbitrary optical fiber is received by an arbitrary end node, is characterized by comprising

means for setting a current optical path on a route via the clockwise or counterclockwise optical transmission line extending from the start node to the end node, and setting a spare optical path on a route reverse to the current optical path extending from the start node to the end node,

means for sharing the spare optical path among the current optical paths having different routes,

means for, when a node which terminates the current optical path detects a trouble pertaining to reception of an optical signal, outputting an optical signal to both the current optical path and the spare optical path, sending an alarm signal to an opposite node of the current optical path having the trouble, and switching inputting of optical signals to the spare optical path, and

means for, when a node which terminates the current optical path detects the alarm signal, outputting an optical signal to both the current optical path and the spare optical path, and switching inputting of optical signals to the spare optical path.

According to the present invention, a node of a wavelength division multiplexing ring network system which comprises an optical transmission line including at least a clockwise optical transmission line and a counterclockwise optical transmission line, and a plurality of nodes connected into the form of a ring via the transmission line to transmit and receive a plurality of optical signals having different wavelengths, terminate optical paths, and switch connections of the optical paths, and in which an optical path having an arbitrary wavelength is set by which an optical signal transmitted from an arbitrary start node through an arbitrary optical fiber is received by an arbitrary end node, is characterized by comprising

means for setting a current optical path on a route via the clockwise or counterclockwise optical transmission line extending from the start node to the end node, and setting a spare optical path on a route reverse to the current optical path extending from the start node to the end node

means for sharing the spare optical path among the current optical paths having different routes,

means for, when a node which terminates the current optical path detects a trouble pertaining to reception of an optical signal, outputting an optical signal to both the current optical path and the spare optical path, sending an alarm signal to an opposite node of the current optical path having the trouble, and switching inputting of optical signals to the spare optical path, and

means for, when a node which terminates the current optical path detects the alarm signal, outputting an optical signal to both the current optical path and the spare optical path, and switching inputting of optical signals to the spare optical path.

According to the present invention, an optical path setting method in a wavelength division multiplexing ring network system which comprises an optical transmission line including at least a clockwise optical transmission line and a counterclockwise optical transmission line, and a plurality of nodes connected into the form of a ring via the transmission line to transmit and receive a plurality of optical signals having different wavelengths, terminate optical paths, and switch connections of the optical paths, and in which an optical path having an arbitrary wavelength is set by which an optical signal transmitted from an arbitrary start node through an arbitrary optical fiber is received by an arbitrary end node, comprising

setting a current optical path on a route via the clockwise or counterclockwise optical transmission line extending from the start node to the end node, and setting a spare optical path on a route reverse to the current optical path extending from the start node to the end node, and

sharing the spare optical path among the current optical paths having different routes.

According to the present invention, an optical path setting method in a wavelength division multiplexing ring network system which comprises an optical transmission line including at least a clockwise optical transmission line and a counter-clockwise optical transmission line, and a plurality of nodes connected into the form of a ring via the transmission line to transmit and receive a plurality of optical signals having different wavelengths, terminate optical paths, and switch connections of the optical paths, and in which an optical path having an arbitrary wavelength is set by which an optical signal transmitted from an arbitrary start node through an arbitrary optical fiber is received by an arbitrary end node, is characterized by comprising

setting a current optical path on a route via the clockwise or counterclockwise optical transmission line extending from the start node to the end node, and setting a spare optical path on a route reverse to the current optical path extending from the start node to the end node,

sharing the spare optical path among the current optical paths having different routes,

when a node which terminates the current optical path detects a trouble pertaining to reception of an optical signal, outputting an optical signal to both the current optical path and the spare optical path, sending an alarm signal to an opposite node of the current optical path having the trouble, and switching inputting of optical signals to the spare optical path, and

when a node which terminates the current optical path detects the alarm signal, outputting an optical signal to both the current optical path and the spare optical path, and switching inputting of optical signals to the spare optical path.

According to the present invention, an optical path setting method in a wavelength division multiplexing ring network system which comprises a plurality of nodes for transmitting and receiving a plurality of optical signals having different wavelengths, terminating optical paths, and switching connections of the optical paths, and a network manager connected to at least one node, and in which the nodes are connected into the form of a ring via at least a clockwise optical transmission line and a counter-clockwise optical transmission line, and an optical path having an arbitrary wavelength is set by which an optical signal transmitted from an arbitrary start node through an arbitrary optical fiber is received by an arbitrary end node, is characterized by comprising the steps of

setting a current optical path on a route via the clockwise or counterclockwise optical transmission line extending from the start node to the end node, and setting a spare optical path on a route reverse to the current optical path extending from the start node to the end node,

causing the network manager to request at least one node forming an optical path to set an optical path,

causing the node to set an optical path between nodes forming an optical path on the basis of the request from the network manager,

causing optical path requesting means to check whether an optical path can be set, determine a node to be requested to set an optical path, and check whether the spare optical path can be shared,

causing optical path setting means to set an insertion wavelength of an optical path, set a conversion wavelength of an optical path, and set a branching wavelength of an optical path,

causing means for checking whether the spare optical path can be shared to determine that the spare optical path can be shared when routes of the current optical paths set between nodes do not overlap, and request at least one node to set an optical path so as to form a new spare optical path by sharing an existing spare optical path, and

causing optical path setting means to form a new spare optical path by sharing a wavelength used by an existing spare optical path, when requested by the network manager to form the new spare optical path by sharing the existing spare optical path.

According to the present invention, a recovery method in a wavelength division multiplexing ring network system which comprises an optical transmission line including at least a clockwise optical transmission line and a counterclockwise optical transmission line, and a plurality of nodes connected into the form of a ring via the transmission line to transmit and receive a plurality of optical signals having different wavelengths, terminate optical paths, and switch connections of the optical paths, and in which an optical path having an arbitrary wavelength is set by which an optical signal transmitted from an arbitrary start node through an arbitrary optical fiber is received by an arbitrary end node, is characterized by comprising

setting a current optical path on a route via the clockwise or counterclockwise optical transmission line extending from the start node to the end node, and setting a spare optical path on a route reverse to the current optical path extending from the start node to the end node,

sharing the spare optical path among the current optical paths having different routes,

when a node which terminates the current optical path detects a trouble pertaining to reception of an optical signal, outputting an optical signal to both the current optical path and the spare optical path, sending an alarm signal to an opposite node of the current optical path having the trouble, and switching inputting of optical signals to the spare optical path, and

when a node which terminates the current optical path detects the alarm signal, outputting an optical signal to both the current optical path and the spare optical path, and switching inputting of optical signals to the spare optical path.

The optical path setting method and the recovery method, configured as above, in the wavelength division multiplexing ring network system can also achieve the same effects as the wavelength division multiplexing ring network system of the present invention described above.

The present invention can also be implemented as a program.

In the present invention, a spare optical path is shared by current optical paths having different routes, so the number of wavelengths necessary to form a spare optical path can be reduced. This can increase the number of optical paths capable of being accommodated.

A current optical path is allocated by the shortest route, so the route of a spare optical path becomes longer than that of a current optical path. Since this increases the degree of sharing of a spare optical path, the number of optical paths capable of being accommodated can be increased.

Also, a current optical path and a spare optical path are allocated in two ways, so the route of a spare optical path becomes longer than that of a current optical path. Since this increases the degree of sharing of a spare optical path, the number of optical paths capable of being accommodated can be increased.

As node operations when a trouble occurs in a current optical path:

1. Optical signals are output to both the current optical path and a spare optical path.

2. An alarm signal is sent.

3. Inputting of optical signals is switched to the spare optical path.

Also, as node operations when an alarm signal is detected:

1. Optical signals are output to both a current optical path and a spare optical path.

2. Inputting of optical signals is switched to the spare optical path.

Therefore, no messages need be notified between terminal nodes of an optical path when a trouble occurs, so recovery from the trouble can be performed by an extremely simple operation.

Furthermore, the optical path requesting means comprises the step of checking whether a spare optical path can be shared, and the optical path setting means comprises the step of forming a spare optical path by sharing the wavelength. Since a spare optical path can be shared by current optical paths having different routes, the number of wavelengths necessary to form a spare optical path can be reduced. This makes it possible to increase the number of optical paths capable of being accommodated.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention and, together with the generation description given above and the detailed description of the embodiments given below, serve to explain the principles of the invention.

FIG. 1 is a view showing a conventional WDM ring network system;

FIG. 2 is a view showing the configuration of a WDM ring network system according to the present invention;

FIG. 3 is a block diagram showing details of an optical path manager 10 shown in FIG. 2;

FIG. 4 is a view showing an example of a configuration management table 22;

FIG. 5 is a view showing an example of an optical path management table 24;

FIG. 6 is a view showing an example of an optical path sharing table 26;

FIG. 7 is a block diagram showing details of a WDM transmitter shown in FIG. 2;

FIG. 8 is a block diagram showing details of an optical path controller 16 shown in FIG. 2;

FIGS. 9A through 9C are views showing examples in which a current optical path and a spare optical path are allocated between two nodes in the WDM ring network system according to the present invention;

FIG. 10 is a flow chart showing the operation, related to optical path allocation, of a network manager;

FIG. 11 is a flow chart showing details of the operation of step 4 in FIG. 10;

FIGS. 12A through 12C are views showing examples of updated optical path sharing tables 26 when optical paths are sequentially allocated in accordance with setting requests 1 through 3;

FIG. 13 is a view showing an example of the format of optical path information used to notify optical path allocation to a node;

FIG. 14 is a view showing an example of optical path information transferred from the network manager to a node B;

FIGS. 15A through 15E are views showing the states of optical path control tables 58 of nodes related to a clockwise ring, immediately before a spare optical path corresponding to setting request 3 is allocated;

FIG. 16 is a flow chart showing operation performed by an optical path control unit 54 when optical path information having an allocation request described in a control ID is received;

FIG. 17 is a flow chart showing details of the operation of step 7 shown in FIG. 16;

FIG. 18 is a flow chart showing details of the operation of step 9 shown in FIG. 16;

FIG. 19 is a flow chart showing details of the operation of step 10 shown in FIG. 16;

FIG. 20 is a flow chart showing operation performed by the optical path control unit 54 when optical path information having allocation confirmation described in a control ID is received;

FIGS. 21A through 21E are views showing the states of the optical path control tables 58 of the nodes related to the clockwise ring, immediately after the spare optical path corresponding to setting request 3 is allocated;

FIG. 22 is a view showing an example of optical path information transferred from the network manager to the node B;

FIG. 23 is a flow chart showing operation performed by the optical path control unit 54 when optical path information having a release request described in a control ID is received;

FIG. 24 is a flow chart showing operation performed by the optical path control unit 54 when optical path information having release confirmation described in a control ID is received;

FIGS. 25A through 25E are views showing the states of the optical path control tables 58 of the nodes related to the clockwise ring, immediately after a spare optical path corresponding to setting request 1 is released;

FIG. 26 is a graph showing the results of calculations of blocking probability by computer simulation, when optical paths are dynamically allocated on the basis of the present invention between two nodes constituting a WDM ring network system;

FIG. 27 is a graph showing the results of calculations, obtained by similar computer simulation, of the number of optical paths capable of being accommodated before blocking occurs, when the number of wavelengths of a one-way (clockwise or counterclockwise) ring in a 7-node WDM ring network system is changed;

FIG. 28 is a schematic view showing that a trouble occurs in a clockwise optical transmission line between nodes C and D;

FIG. 29 is a flow chart showing recovery operation executed in the WDM ring network system;

FIGS. 30A through 30D are views showing an example of operation of recovery from a trouble of an optical path of OID1; and

FIGS. 31A and 31B are views showing an example of operation of recovery from a trouble of the optical path of OID1, when two-way optical fibers connecting the nodes C and D are broken.

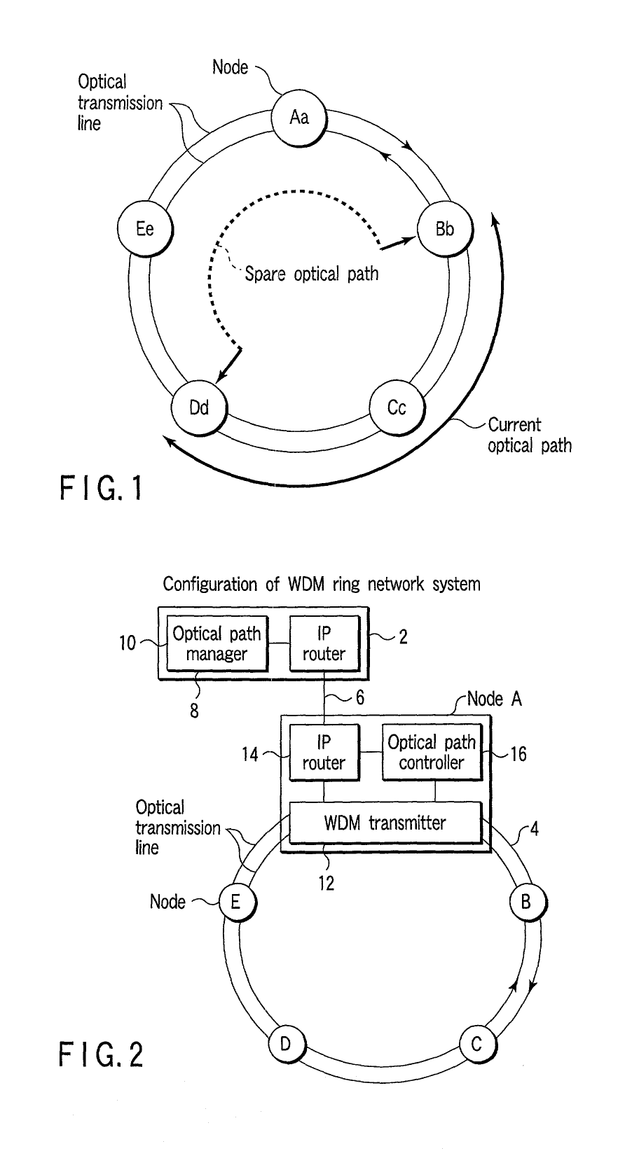

### DETAILED DESCRIPTION OF THE INVENTION

(First Embodiment)

The first embodiment of an apparatus according to the present invention will be described below with reference to the accompanying drawing.

First, the following terms are defined.

The term “wavelength multiplexing” means that a plurality of optical signals having different wavelengths are transmitted as they are multiplexed, in an optical transmission line connecting nodes. More specifically, this term means that optical signals are multiplexed using an insertion wavelength, branching wavelength, and conversion wavelength. The insertion wavelength is used for an optical signal to be inserted from a node. The branching wavelength is used for an optical signal to be branched at a node. The conversion wavelength is used for wavelength conversion of an optical signal at a node. This conversion wavelength is composed of an input wavelength before conversion and an output wavelength after conversion. Accordingly, even the same wavelength is set as the branching wavelength at a certain node and as the conversion wavelength or insertion wavelength at another node.

The term “start node” means a node as the start point of an optical path. The insertion wavelength is used at this start node.

The term “relay node” means a node for relaying an optical path. The conversion wavelength is used at this relay node.

The term “end node” means a node as the end point of an optical path. The branching wavelength is used at this end node.

The term “optical path” means a communication path formed on a route in which an optical signal inserted from a start node is passed through a relay node and branched at an end node, in communication between two arbitrary nodes. Optical paths include an optical path of a current system (to be referred to as a current optical path hereinafter) used in normal operation, and an optical path of a spare system (to be referred to as a spare optical path hereinafter) used in place of a current optical path when a trouble occurs. These two types of optical paths are generally called optical paths.

The term “set” means that the wavelength of an optical path is allocated or released.

FIG. 2 shows the configuration of a WDM ring net system according to the present invention. This system comprises five nodes A through E, a network manager (to be referred to as an NMS hereinafter) 2, an optical transmission line 4 for connecting the nodes, and a transmission line 6 for connecting the nodes and the NMS 2. Adjacent nodes are connected by two optical fibers to form a ring-like topology, and wavelength-multiplexed optical signals are transmitted clockwise or counterclockwise. The NMS 2 includes an IP router 8 and an optical path manager 10. Each of the nodes A through E includes a WDM transmitter 12, an IP router 14, and an optical path controller 16. Between the NMS 2 and the node A, the IP routers 8 and 14 are connected via the transmission line 6. The IP routers 14 of the individual nodes are connected by a default path via the WDM transmitters 12 and the optical transmission line 4.

A default path means a communication path formed on a route in which an optical signal inserted from a certain node is branched to adjacent nodes. In this embodiment of the present invention, at least one default path is present between adjacent nodes.

Note that in this WDM ring network system, an IP routing protocol (e.g., OSPF (Open Shortest Path First)) is operating, so the optical path manager 10 and the optical path controllers 16 can communicate with each other via the IP routers and the default path.

It is also possible to increase or decrease the number of nodes, to connect adjacent nodes by a single optical fiber and perform two-way communication between the nodes by using wavelengths in different wavelength bands (e.g., a 1.3-μm band and a 1.5-μm band), and to connect adjacent nodes by two or more optical fibers. The nodes A through E or the WDM transmitters 12 of these nodes can include a function (e.g., an SDH transmitter) of transmitting an optical signal by mapping the signal on a transmission frame. Furthermore, the NMS 2 and the IP routers 14 of the nodes A through E can be replaced with other devices (e.g., ATM switches) where necessary. That is, the configuration of the WDM ring network system and the arrangements of the NMS 2 and the nodes can be variously modified.

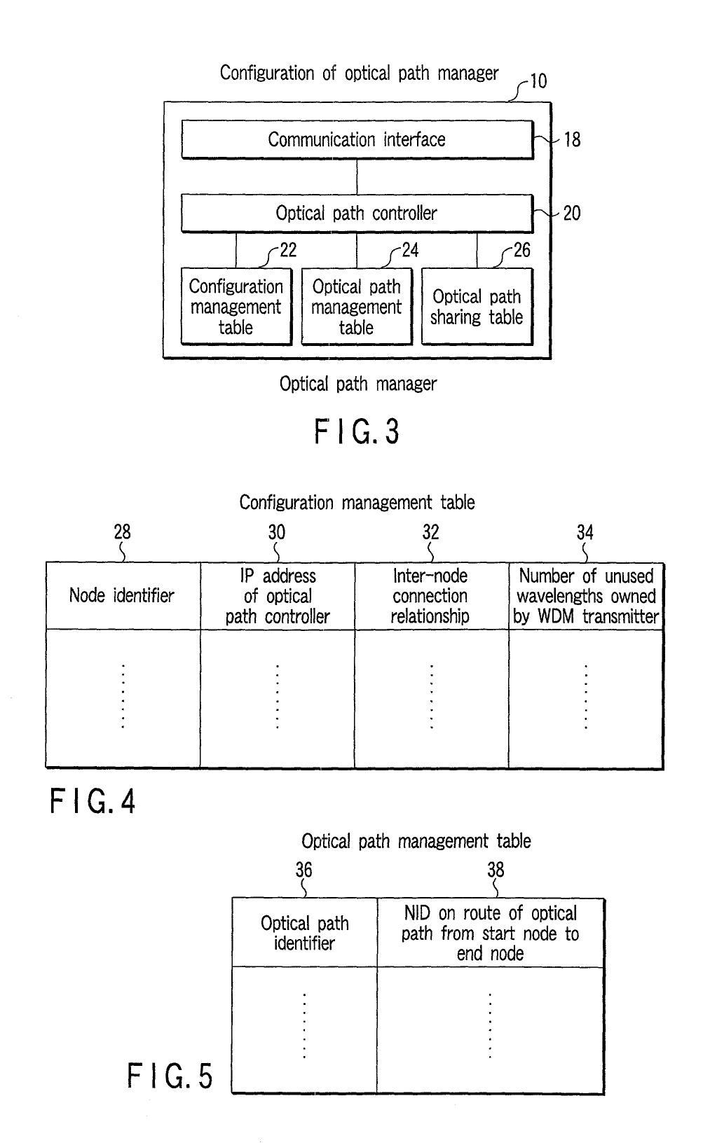

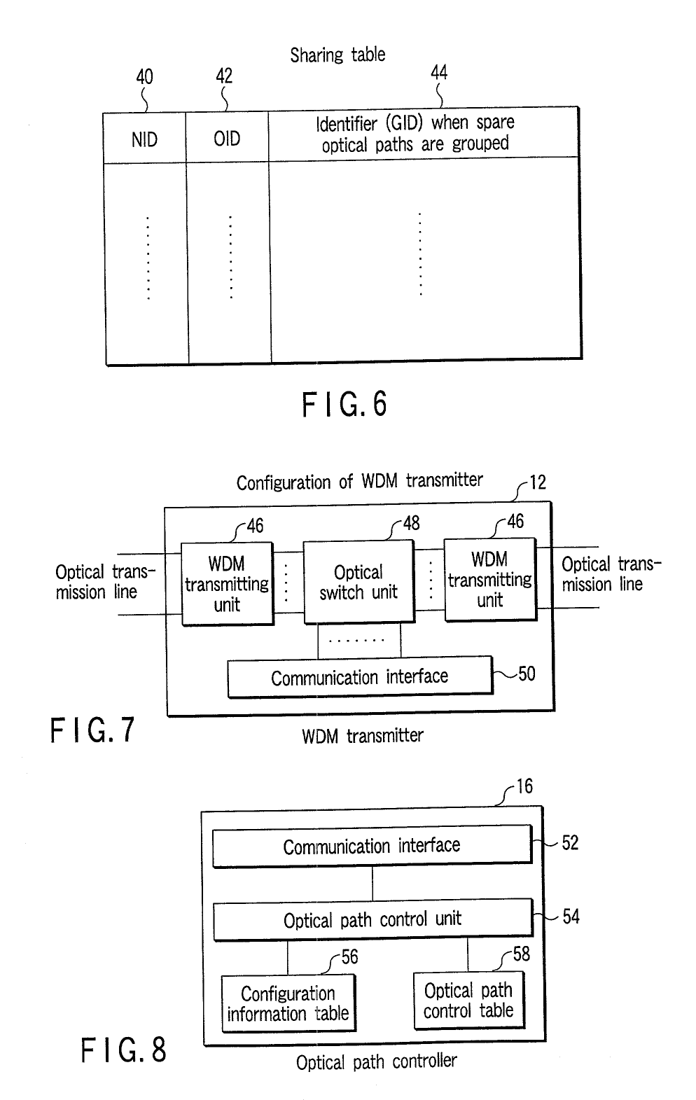

FIG. 3 shows the arrangement of the optical path manager 10 included in the NMS 2. This optical path manager 10 comprises a communication interface 18 for exchanging various pieces of information with the IP router 8, with other devices, and with an operator, an optical path controller 20, a configuration management table 22, an optical path management table 24, and an optical path sharing table 26. The optical path controller 20 manages the settings of optical paths on the basis of information exchanged via the communication interface 18. As shown in FIG. 4, the configuration management table 22 describes a node identifier (to be referred to as an NID hereinafter) 28, an IP address (to be referred to as an NIP hereinafter) 30 of the optical path controller 16, an inter-node connection relationship 32, and the number of unused wavelengths, denoted by reference numeral 34, owned by the WDM transmitter. As shown in FIG. 5, the optical path management table 24 describes an optical path identifier (to be referred to as an OID hereinafter) 36 and an NID 38 on the route of an optical path from a start node to an end node. As shown in FIG. 6, the optical path sharing table 26 describes an NID 40, an OID 42, and an identifier (to be referred to as a GID hereinafter) 44 when spare optical paths are grouped.

Note that the configuration management table 22 can be generated on the basis of information exchanged with an operator via the communication interface 18, or on the basis of information exchanged by communication between the optical path manager 10 and the optical path controller 16. Note also that both the NID and the NIP are described in the configuration management table 22. However, if the optical path manager 10 includes a method of deriving the NID from the NIP or vice versa, one of the NID and the NIP need only be described. Also, the number of unused wavelengths owned by the WDM transmitter 12 is described in the configuration management table 22. However, the use states of wavelengths corresponding to the settings of optical paths can also be described. If the NMS 2 does not check whether optical paths are set, the number of unused wavelengths owned by the WDM transmitter 12 need not be described. Furthermore, the optical path management table 24 and the optical path sharing table 26 can be combined into a single table, or all the tables can be combined. That is, the configurations of tables in the optical path manager 10 can be variously modified.

FIG. 7 shows the arrangement of the WDM transmitter 12 included in a node. This WDM transmitter 12 comprises a pair of WDM transmitting units 46 for exchanging wavelength-multiplexed optical signals with the WDM transmitters 12 of adjacent nodes, an optical switch unit 48, and a communication interface 50 for exchanging various pieces of information with the IP router 14 and the optical path controller 16. The WDM transmitting units 46 and the optical switch unit 48 have a function pertaining to wavelength insertion/branching/conversion, a function related to switching between inputting and outputting of optical signals, and a function pertinent to transmission of optical signals.

Referring to FIG. 7, the pair of WDM transmitting units 46 and the one optical switch unit 48 process optical signals input and output through a plurality of optical fibers, and the one communication interface 50 exchanges diverse pieces of information with the IP router 14 and the optical path controller 16. However, it is also possible to use a plurality of WDM transmitting units 46 and a plurality of optical switch units 48 in one-to-one correspondence with the inputs and outputs of optical fibers, and to use a plurality of communication interfaces 50 as needed. That is, the arrangement of the WDM transmitter 12 can be variously modified.

FIG. 8 shows the arrangement of the optical path controller 16 included in each of the nodes A through E. This optical path controller 16 comprises a communication interface 52 for exchanging diverse pieces of information with the IP router 14, with the WDM transmitter 12, and with other devices, an optical path control unit 54, a configuration information table 56, and an optical path control table 58. The optical path control unit 54 controls the settings of optical paths on the basis of information exchanged via the communication interface 52. The configuration information table 56 describes the NIDs and NIPs of adjacent nodes. The optical path control table 58 describes the use states of wavelengths owned by the WDM transmitter 12 and the set states of optical paths.

Note that the configuration information table 56 can be generated on the basis of information exchanged by communication between the optical path controllers 16 of adjacent nodes, or on the basis of information exchanged by communication with the optical path manager 10. Note also that both the NID and the NIP are described in the configuration information table 56. However, if the optical path controller 16 includes a method of deriving the NID from the NIP or vice versa, one of the NID and the NIP need only be described in the configuration information table 56. Furthermore, the configuration information table 56 and the optical path control table 58 can be combined into a single table. That is, the configurations of tables in the optical path controller 16 can be variously modified.

(Operation Related to Allocation of Optical Path)

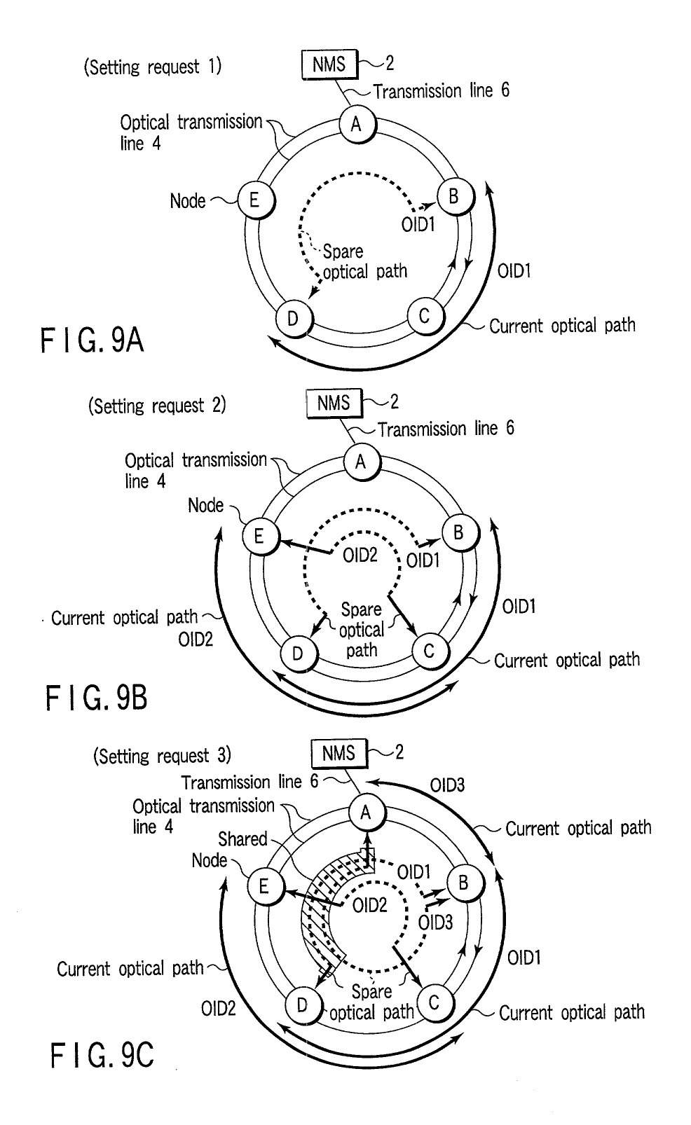

FIGS. 9A through 9C illustrate examples in which a current optical path and a spare optical path are allocated between two nodes in the WDM ring network system according to the present invention. A hatched portion indicates a portion where a spare optical path is shared.

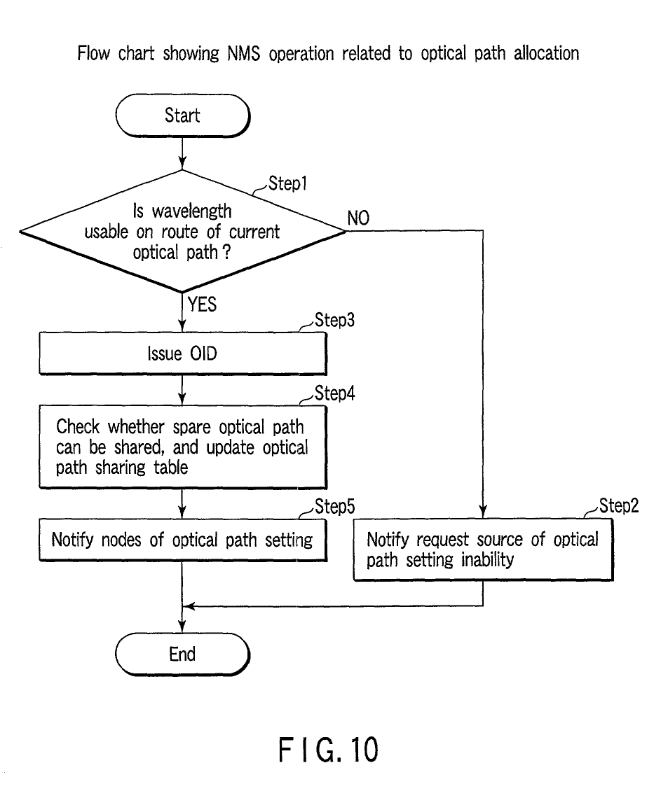

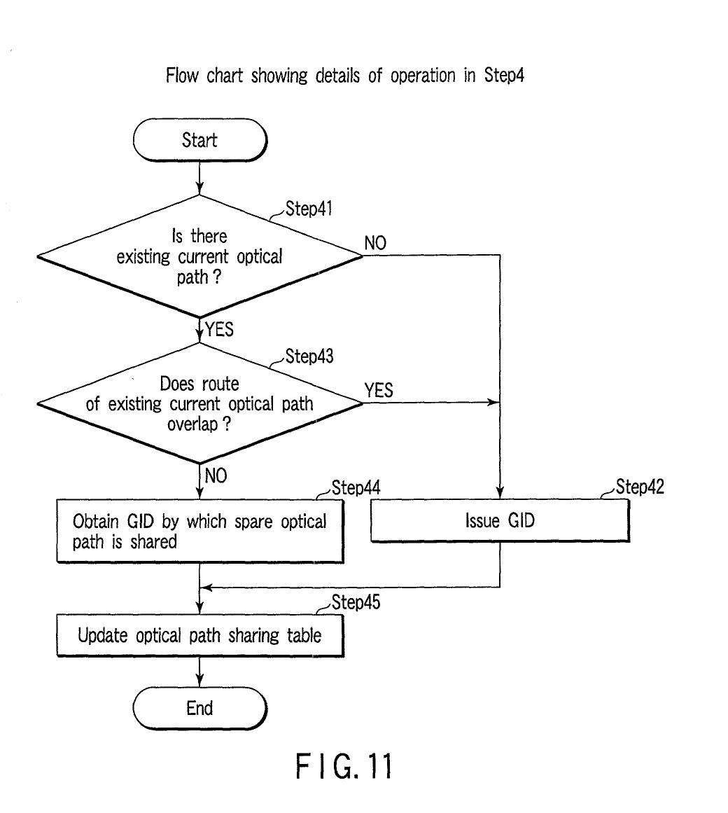

FIG. 10 is a flow chart showing the operation, pertaining to the settings of optical paths, of the NMS 2. In this embodiment, assume that when no optical paths are allocated to the WDM ring network system, a request source (an operator or another device) sequentially requests, to the optical path controller 20 via the communication interface, the allocation of current optical paths between the nodes B-C-D, the nodes C-D-E, and the nodes A-B, by setting requests 1, 2, and 3, respectively.

To allocate an optical path between nodes, the request source designates the route of a current optical path by the NID or NIP. When requested to allocate an optical path, the optical path controller 20 performs processing in accordance with the flow chart shown in FIG. 10. In step 1, the optical path controller 20 looks up the configuration management table 22 on the basis of the designated route to check whether wavelengths can be used at all nodes on the route to allocate a current optical path. If no current optical path can be allocated owing to the lack of wavelengths, in step 2 the optical path controller 20 notifies the request source of this information. If a current optical path can be allocated, in step 3 the optical path controller 20 issues a unique OID. In step 4, the optical path controller 20 looks up the optical path sharing table 26 to check whether a spare optical path can be shared, and also updates this optical path sharing table 26. In step 5, the optical path manager 26 notifies the nodes of the allocation of an optical path.

Note that when the request source is to designate the route of a current optical path, this request source need not designate any relay nodes or can designate some relay nodes. In this case, the optical path controller 20 looks up the configuration management table 22 to select the shortest route between nodes or a route having a large number of usable wavelengths, thereby determining the route of the current optical path. Note also that the request source can designate a practical route selecting method to the optical path controller 20 via the communication interface.

FIG. 11 is a flow chart showing details of the operation of step 4 shown in FIG. 10. To check whether a spare optical path can be shared, the optical path controller 20 checks in step 41 whether there is an existing current optical path. If there is no existing current optical path, the optical path controller 20 does not allow sharing of the spare optical path and, in step 42, issues a unique GID required to set a new spare optical path. If there is an existing current optical path, the optical path controller 20 checks in step 43 whether the route of the existing current optical path overlaps that of a new current optical path. If the routes overlap each other, the spare optical path cannot be shared, so the optical path controller 20 performs the same processing as in step 42. If the routes do not overlap each other, the spare optical path can be shared. In step 44, therefore, the optical path controller 20 looks up the optical path sharing table 26 to obtain a GID by which the spare optical path is shared. In step 45, the optical path controller 20 updates the optical path sharing table 26 on the basis of the above processing result.

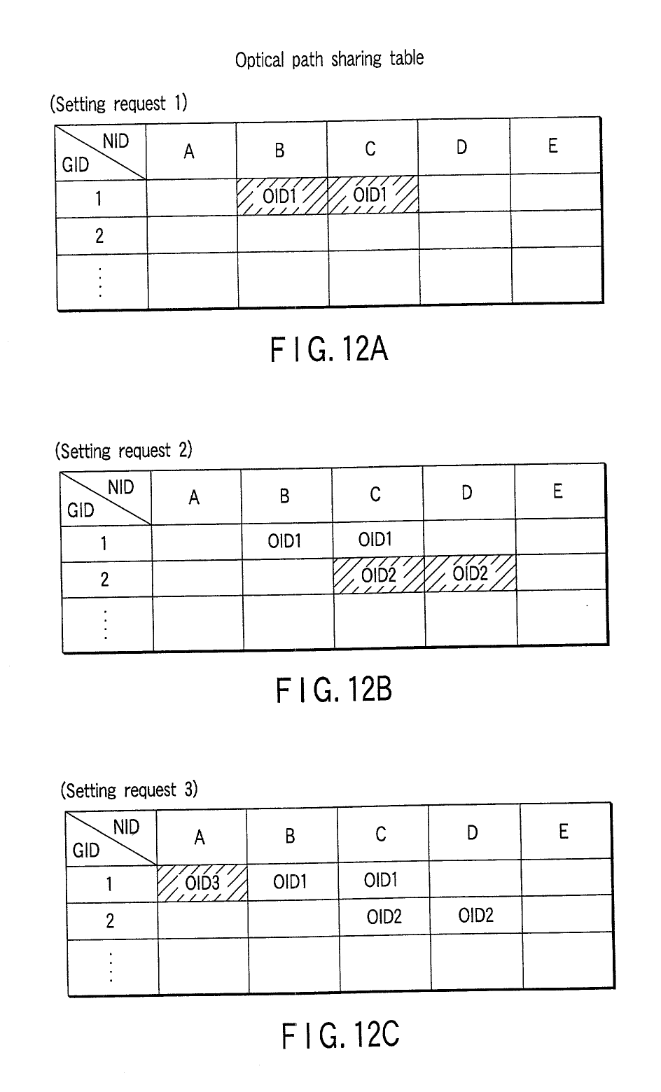

FIGS. 12A through 12C illustrate examples of the optical path sharing table 26 updated in step 45 when optical paths are sequentially allocated in accordance with setting requests 1 through 3 described above. The row direction of the table corresponds to a GID, the column direction corresponds to an NID, and an OID is described in each element. Referring to FIGS. 12A through 12C, portions updated by the processing are hatched. The operation related to optical path allocation will be described in detail below with reference to FIGS. 10 through 12C.

Although an optical path is allocated in two ways (i.e., clockwise and counterclockwise) between nodes, only the allocation of a clockwise optical path will be explained below. Assume that the WDM transmitter of each node has an enough number of wavelengths to allocate optical paths with respect to setting requests 1 through 3 described above.

First, a case in which the allocation of a current optical path between the nodes B-C-D is requested by setting request 1 will be explained. When requested to allocate an optical path, the optical path controller 20 performs processing in accordance with the flow chart shown in FIG. 10. In step 3, the optical path controller 20 issues OID1. Since the optical path manager 10 determines in step 41 that there is no existing current optical path, the optical path controller 20 issues GID1 in step 42. In step 45, as shown in FIGS. 12A through 12C, the optical path controller 20 writes OID1 in columns where the issued GID meets the start node and relay node of the new current optical path.

In the examples shown in FIGS. 12A through 12C, OIDs are written in columns where GIDs meet the start node and relay node. However, OIDs can also be written in columns where GIDs meet the relay node and end node.

Next, a case in which the allocation of a current optical path between the nodes C-D-E is required by setting request 2 will be explained. In accordance with the flow chart shown in FIG. 10, the optical path controller 20 issues OID2 in step 3. In step 43, the optical path controller 20 determines that there is an existing current optical path, and that the route of this existing current optical path overlaps the route of the new current optical path. Accordingly, the optical path controller 20 issues GID2 in step 42. Overlapping of the routes is determined by checking whether OIDs are described in columns where the GID meets the start node and relay node in the optical path sharing table 26. Since OID1 is described in the column of the node C, the optical path controller 20 determines that the routes of the existing current optical path (OID1) and the new current optical path (OID2) overlap. In step 45, the optical path controller 20 updates the optical path sharing table 26 by the same processing as for setting request 1. As shown in FIGS. 12A through 12C, the optical path controller 20 writes OID2 in the optical path sharing table 26 on the basis of the above processing result.

Finally, a case in which the allocation of a current optical path between the nodes A-B is requested by setting request 3 will be explained. In accordance with the flow chart shown in FIG. 10, the optical path controller 20 issues OID3 in step 3. In step 43, the optical path controller 20 determines that there are existing current optical paths, and that the routes of these existing current optical paths do not overlap the route of the new current optical path. Accordingly, the optical path controller 20 selects a GID by which the spare optical path is shared. Overlapping of the routes is determined by the same processing as for setting request 2. In this case, the optical path controller 20 determines that the routes of the existing current optical paths (OID1 and OID2) and the new current optical path (OID3) do not overlap. Note that a GID by which the spare optical path is shared can be selected from GIDs having no OIDs described. In this example, assume that GID1 is chosen. In step 45, as shown in FIGS. 12A through 12C, the optical path controller 20 writes OID3 in a column where GID1 meets the start node and relay node of the new current optical path.

Note that in step 41, the presence/absence of an existing current optical path can also be determined by looking up the optical path management table 24. Also, in step 44 in the above example, GID1 is chosen as a GID by which the spare optical path is shared. However, the processing is obviously the same even when GID2 is selected. Furthermore, in step 45, the OIDs are written in columns where the GID meets the start node and relay node of the new current optical path. However, the OIDs can also be written in columns where the GID meets the end node and relay node of the new current optical path.

In the above explanation, clockwise optical paths are allocated. However, the processing is evidently the same even when counterclockwise optical paths are allocated. Also, the operation related to setting requests 1 through 3 is explained above. However, optical paths can be allocated in the same manner as above even when the routes of current optical paths are different or other optical path setting requests follow setting request 3 continue.

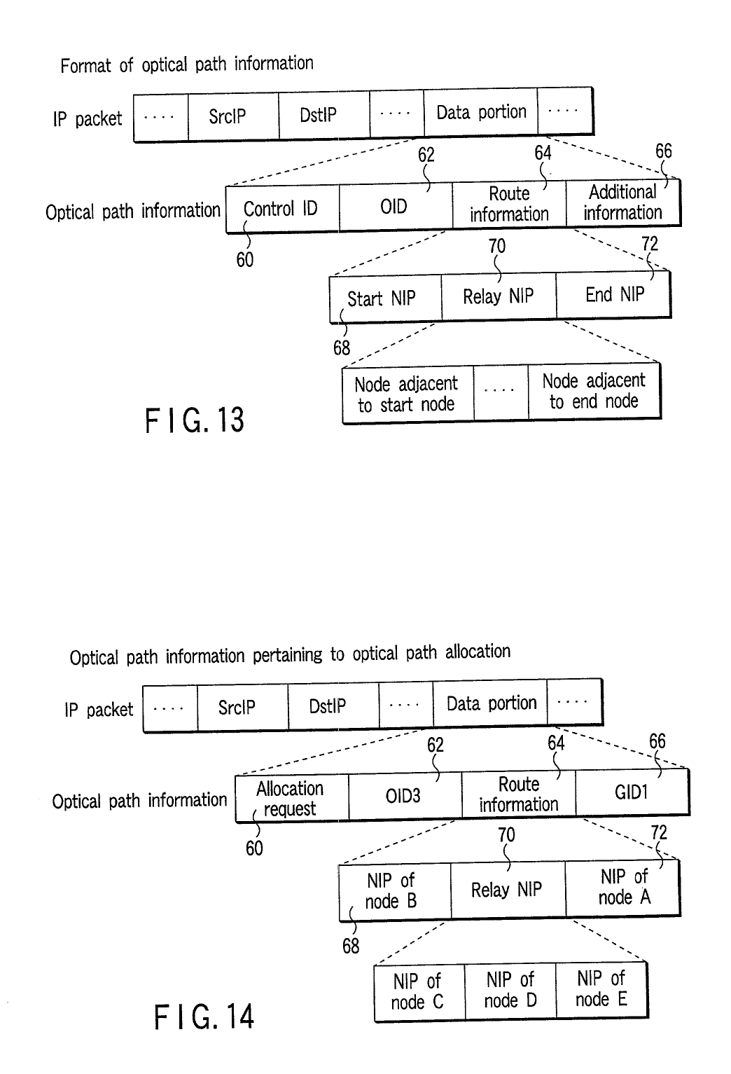

FIG. 13 shows an example of the format of optical path information used to notify nodes of optical path allocation in step 5 shown in FIG. 10. This optical path information is contained in a data portion of an IP packet and exchanged between the NMS 2 and nodes or between nodes. The optical path information contains a control ID 60, an OID 62, route information 64, and additional information 66. The control ID 60 is used to identify the type of control pertaining to the setting of an optical path. In this control ID 60, a value indicating one of an allocation request, allocation confirmation, allocation inability, a release request, release confirmation, and release inability is described. The OID 62 is used to identify individual optical paths. In this OID 62, a unique inherent value issued and managed by the optical path controller 20 is described. The route information 64 is used to identify the route of an optical path. This route information 64 is composed of a start node identifier (to be referred to as a start NIP hereinafter) 68, a relay node identifier (to be referred to as a relay NIP hereinafter) 70, and an end node identifier (to be referred to as an end NIP hereinafter) 72. The IP address of the optical path controller 16 is described in each of these identifiers. The additional information 66 is additional information related to the setting of an optical path. When a spare path is to be set, a GID determined in accordance with the flow chart shown in FIG. 11 is described in this additional information 66. FIG. 13 shows only a transmission source IP address (to be referred to as SrcIP hereinafter) contained in an IP packet, a destination IP address (to be referred to as DstIP hereinafter), and a data portion. When the optical path information is transferred from the NMS 2, the IP address of the optical path manager 10 is described in SrcIP. When the optical path information is transferred from a node, the NIP of the node as the transfer source is described in SrcIP.

Note that in the relay NIP contained in the route information, a plurality of NIPs can be described where necessary, or no NIP need be described if there is no relay node. When a plurality of NIPs are to be described, these NIPs can be described in order along the route of an optical path. Note also that in the route information, the NID or both the NIP and NID of a node for setting an optical path can be described. When the route information is exchanged by describing an NID in it, an NIP can be derived from the NID in the optical path manager 10 or the optical path controller 16. When a current optical path is to be set, nothing need be described in the additional information of the optical path information transferred from the NMS 2 to a node.

Note that the IP address of the optical path manager 10 is detected by the optical path control unit 54 of the optical path controller 16, on the basis of information exchanged by communication between the optical path manager 10 and the optical path controller 16.

The format of the optical path information shown in FIG. 13 is merely an example, so this format can be variously modified.

Operation of allocating a new spare optical path by sharing an existing spare optical path will be described below. That is, operation of allocating a clockwise spare optical path (OID3) related to setting request 3 while optical paths related to setting requests 1 and 2 and a current optical path of setting request 3 shown in FIGS. 9A through 9C exist will be explained in detail below.

To set a new spare optical path (OID3) between the nodes B-C-D-E-A in accordance with setting request 3 by sharing the existing spare optical path (OID1), the optical path controller 20 of the NMS 2 transfers optical path information to the optical path controller 16 of the node B in accordance with the flow chart shown in FIG. 10. FIG. 14 shows an example of the optical path information transferred from the NMS 2 to the node B. An allocation request, OID3, and GID1 obtained by looking up the optical path sharing table 26 are respectively described in the control ID 60, the OID 62, and the additional information 66. In the route information, the NIP of the node B is described in the start NIP 68, and the NIP of the node A is described in the end NIP 72. In the relay NIP 70, the NIPs of the nodes C, D, and E are described in this order along the route of the spare optical path. SrcIP and DstIP of an IP packet containing this optical path information respectively describe the IP address of the optical path manager 10 and the IP address of the node B. The optical information is transferred from the NMS 2 to the node B by packet routing by the IP router.

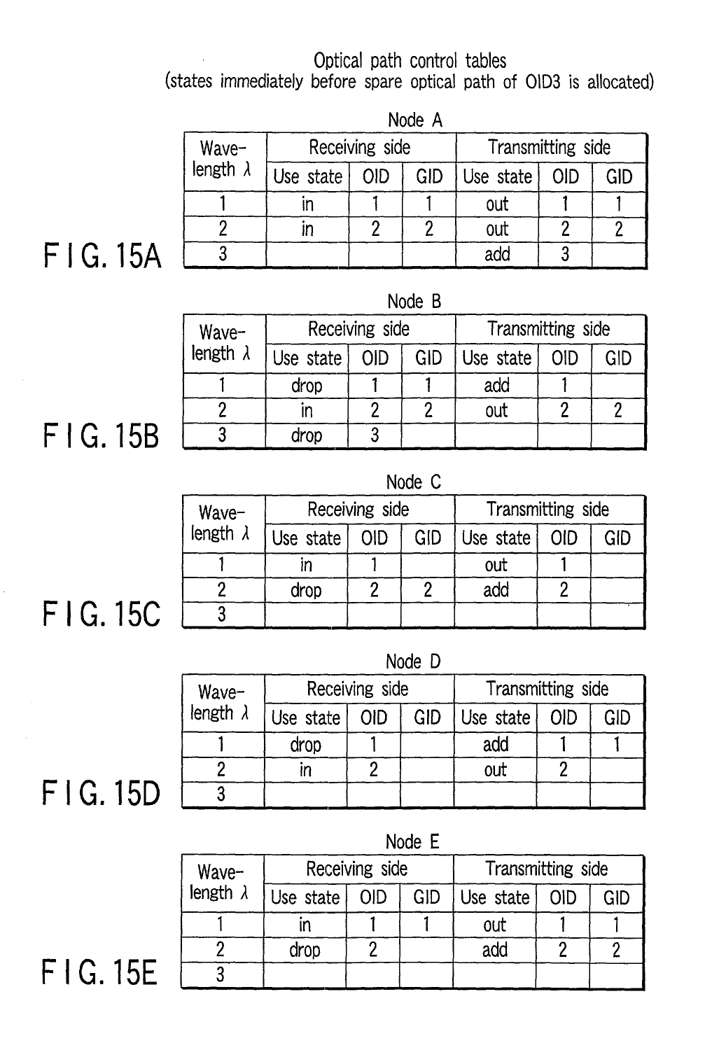

The optical path control unit 54 of each node receives, via the communication interface, optical path information having an allocation request, allocation confirmation, or allocation inability described in the control ID, and performs processing related to optical path allocation. FIGS. 15A through 15E illustrate examples, immediately before the spare optical path (OID3) of setting request 3 is allocated, of the optical path control tables 58 of the individual nodes pertaining to the clockwise ring.

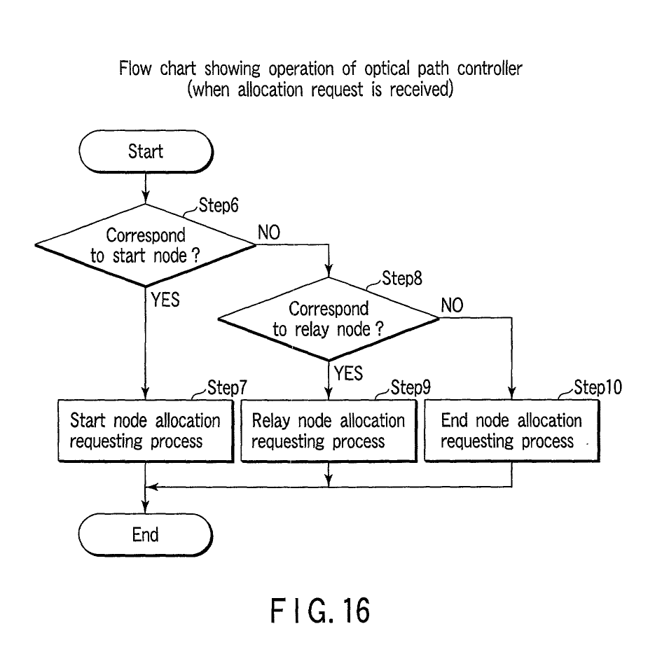

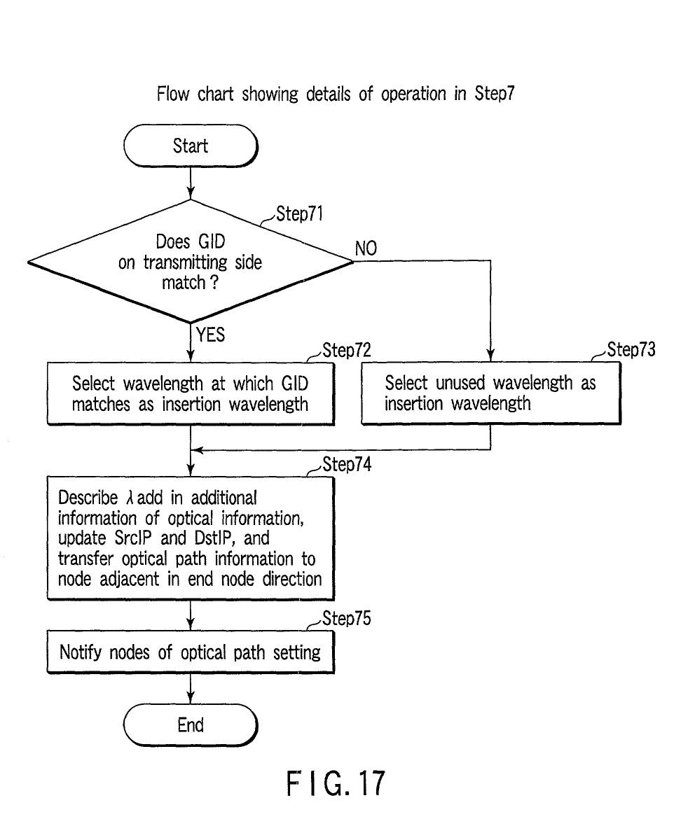

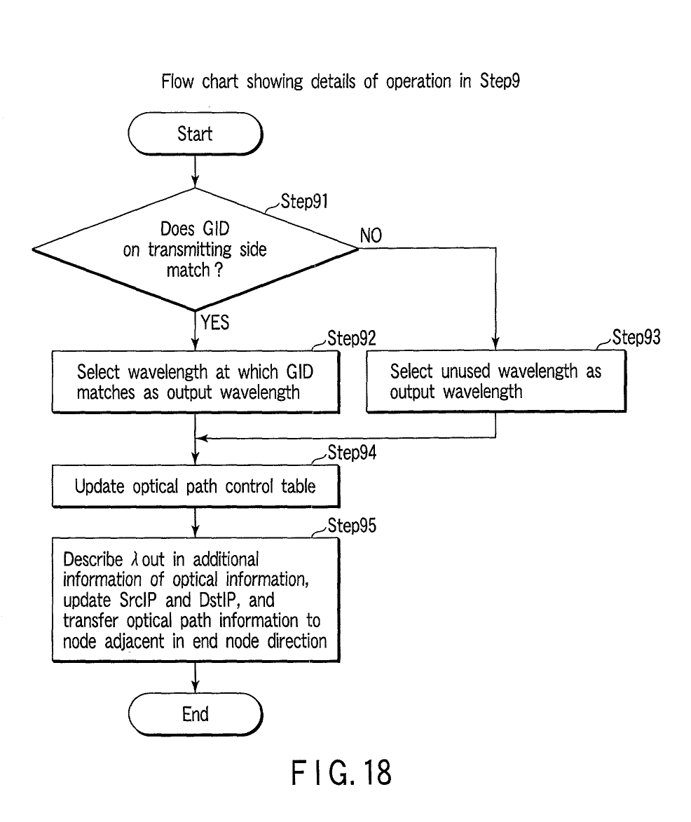

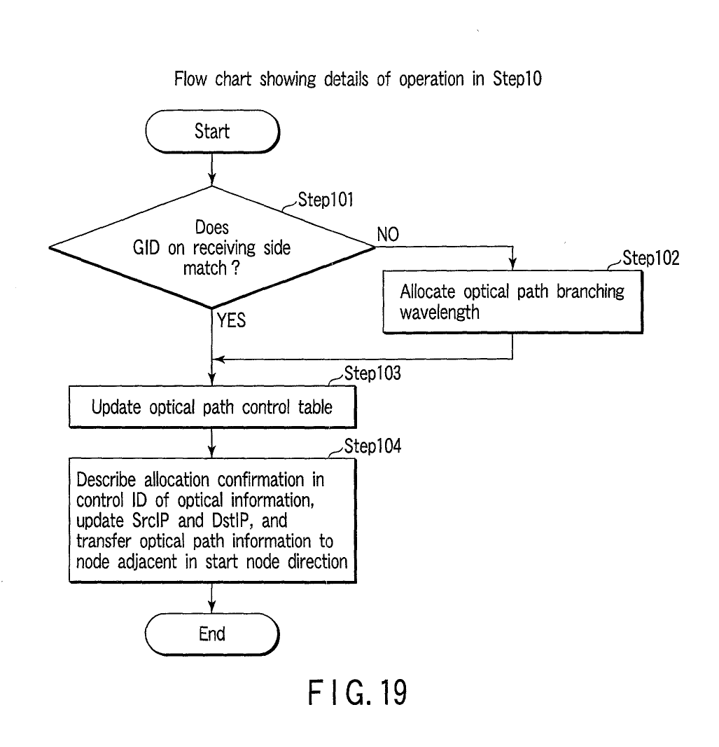

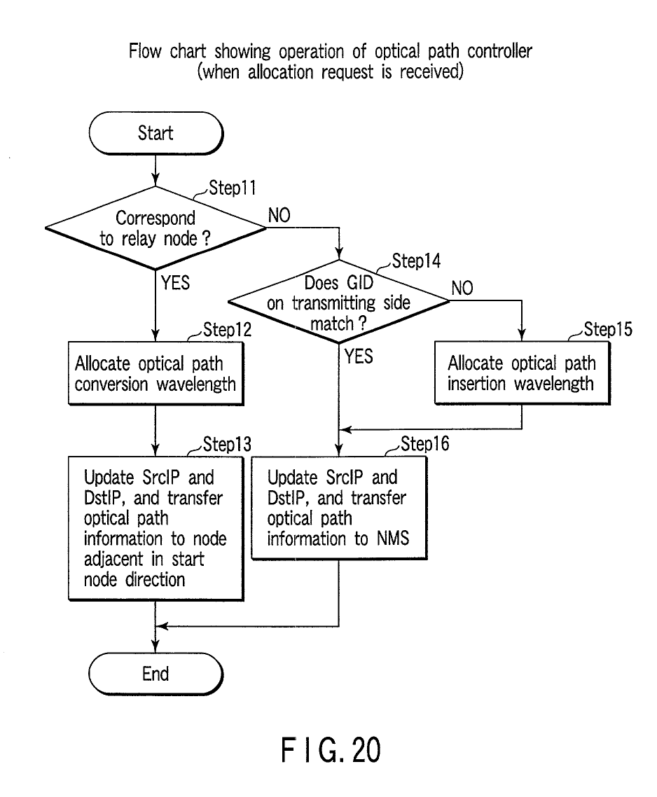

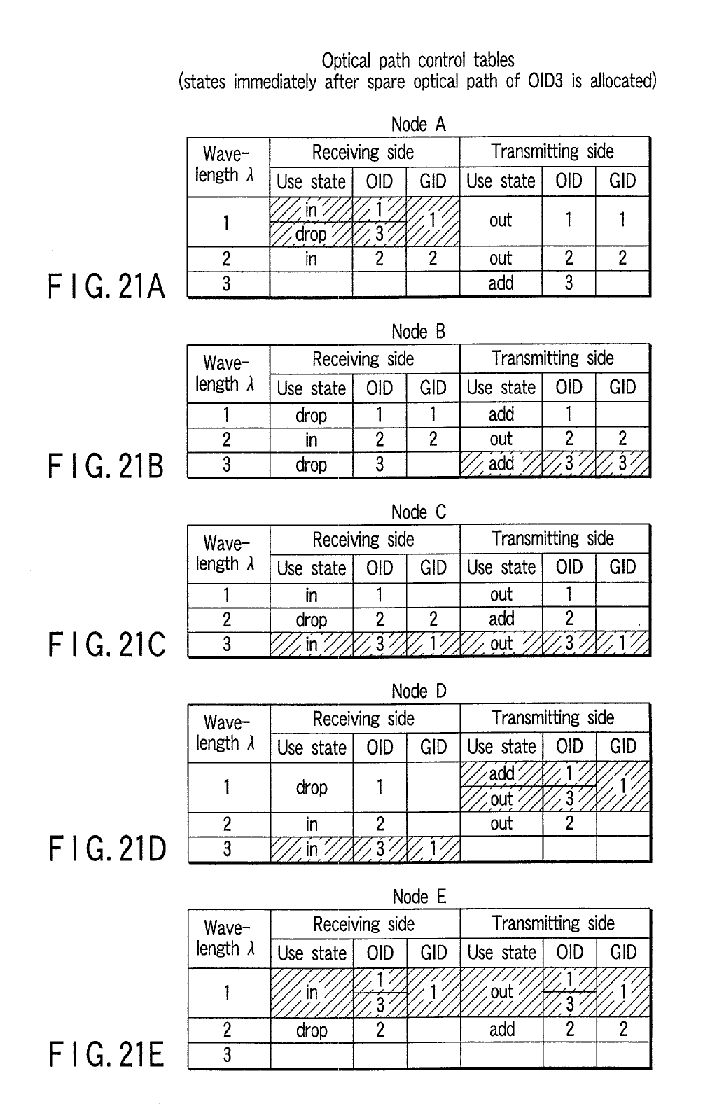

FIG. 16 is an example of a flow chart showing operation performed by the optical path control unit 54 when optical path information having an allocation request described in the control ID is received. FIG. 17 is an example of a flow chart showing details of the operation of step 7 shown in FIG. 16. FIG. 18 is an example of a flow chart showing details of the operation of step 9 shown in FIG. 16. FIG. 19 is an example of a flow chart showing details of the operation of step 10 shown in FIG. 16. FIG. 20 is an example of a flow chart showing operation performed by the optical path control unit 54 when optical path information having allocation confirmation described in the control ID is received. FIGS. 21A through 21E illustrate examples, immediately after the spare optical path (OID3) of setting request 3 is allocated, of the optical path control tables 58 of the individual nodes pertaining to the clockwise ring.

While the optical path control table 58 is used, a wavelength used as the insertion wavelength is described as “add”, a wavelength used before wavelength conversion is described as “in”, a wavelength used after wavelength conversion is described as “out”, and a wavelength used as the branching wavelength is described as “drop”. Also, the value of a wavelength for use in a current optical path is not described in “GID”. As for a wavelength for use in a spare optical path, a value received by the optical path information is described in “GID”. For example, for the current optical path of OID1, a transmitting side wavelength λ1 of the node B as a start node is used as the insertion wavelength, a receiving side wavelength λ1 and a transmitting side wavelength λ1 of the node C as a relay node are used as the conversion wavelengths, and a receiving side wavelength λ1 of the node D as an end node is used as the branching wavelength. That is, the nodes of the current optical path of OID1 are B-C-D clockwise. Therefore, in the optical path control tables 58 shown in FIGS. 15A through 15E, “add” is written in “use state” and “1” is written in “OID” on the transmitting side of the wavelength λ “1” of the node B. Since the node C is a relay node, “in” is written in “use state” and “1” is written in “OID” on the receiving side of the wavelength λ “1”. In addition, “out” is written in “use state” and “1” is written in “OID” on the transmitting side of the wavelength λ “1” of the node C. Finally, since the node D is a terminal node, “drop” is written in “use state” and “1” is written in “OID” on the receiving side of the wavelength λ “1”.

For the spare optical path of OID1, a transmitting side wavelength λ1 of the node D as a start node is used as the insertion wavelength, a receiving side wavelength λ1 and a transmitting side wavelength λ1 of the node E as a relay node are used as the conversion wavelengths, a receiving side wavelength λ1 and a transmitting side wavelength λ1 of the node A as a relay node are also used as the conversion wavelengths, and a receiving side wavelength λ1 of the node B as an end node is used as the branching wavelength. That is, the nodes of the spare optical path of OID1 are D-E-A-B clockwise. Therefore, “add” is written in “use state” and “1” is written in “OID” on the transmitting side of the wavelength λ “1” of the node D. Also, a GID as an identifier when spare optical paths are grouped is the registration of the first spare optical path, so “1” is written in “GID”. Since the next node E is a relay node, “in”, “1”, and “1”, and “out”, “1”, and “1”, are written in “use state”, “OID”, and “GID” on the receiving side and the transmitting side, respectively, of the wavelength λ “1”. Likewise, the node A is also a relay node, so the same values as for the node E are set. Since the node B is a terminal node, “drop” is written in “use state” and “1”s are written in “OID” and “GID” on the receiving side of the wavelength λ “1”.

The nodes of the spare optical path of OID2 are E-A-B-C. As shown in FIGS. 15A through 15E, therefore, “add” is written in “use state”, “2” is written in “OID”, and “2” is written in “GID” on the transmitting side of the wavelength λ “2” of the node E. “2” is written in “GID” because the spare optical path of OID1 cannot be shared. That is, the current optical path of OID1 is B-C-D, and the current optical path of OID2 is C-D-E. If, for example, a trouble occurs between the nodes C and D, the nodes D-E-A-B are used as a spare optical path in the case of OID1, and the nodes E-A-B-C are used as a spare optical path in the case of OID2. Hence, one spare path cannot be shared when current optical paths overlap. For this reason, a new identifier “2” is added as a GID.

Since the node A is a relay node, “in” is written in “use state” and “2”s are written in “OID” and “GID” on the receiving side of the wavelength λ “2”. Also, “out”, “2”, and “2” are written in “use state”, “OID”, and “GID” on the transmitting side of the wavelength λ “2”. Furthermore, the node B is also a relay node, so the same values as for the node A are written. Since the node C is a terminal node, “drop” is written in “use state” and “2”s are written in “OID” and “GID” on the receiving side of the wavelength λ “2”.

More specifically, as the conversion wavelengths, wavelengths having the same value described in “OID” on the receiving and transmitting sides make a pair: the former is an input wavelength before conversion, and the latter is an output wavelength after conversion. Referring to FIGS. 21A through 21E, portions updated from the optical path control tables 58 shown in FIGS. 15A through 15E are hatched.

Upon receiving optical path information having an allocation request described in the control ID, the optical path control unit 54 compares the route information shown in FIG. 14 with the OID of its own node. If determining in step 6 of FIG. 16 that the information corresponds to a start node, the optical path control unit 54 performs a start node allocation requesting process in step 7. If determining that the information does not correspond to a start node and if determining in step 8 that the information corresponds to a relay node, the optical path control unit 54 performs a relay node allocation requesting process in step 9. If determining that the information does not correspond to either a start node or a relay node, the optical path control unit 54 performs an end node allocation requesting process in step 10.

The start node allocation requesting process is performed in accordance with a flow chart shown in FIG. 17. In step 71, the optical path control unit 54 searches GIDs on the transmitting side of the optical path control table 58 for a value matching the GID described in the additional information of the optical path information. If there is a GID that matches, an existing spare optical path can be shared, so in step 72 the wavelength at which the GIDs match is selected as the optical path insertion wavelength. If no GID matches, it is necessary to form a new spare optical path, so in step 73 an unused wavelength is selected as the optical path insertion wavelength. In step 74, the optical path control unit 54 updates the optical path control table 58 on the basis of the above processing result. In step 75, the optical path control unit 54 describes the insertion wavelength selected by the above processing into the additional information of the optical path information, describes the NIP of its own node and the NIP, loaded from the route information, of a node adjacent in the end node direction, into SrcIP and DstIP, respectively, of the IP packet containing the optical path information, and transfers the updated optical path information to the adjacent node.

In the update of the optical path control table 58, “add” is written in “use state” and values received by the optical path information are written in “OID” and “GID” of the corresponding insertion wavelength. When the existing spare optical path is to be shared, values are already described in “use state”, “OID”, and “GID” of the corresponding insertion wavelength, so only necessary values need be added. Accordingly, for the spare optical path of OID3, as shown in FIGS. 21A through 21E, “add”, “3”, and “1” are respectively written in “use state”, “OID”, and “GID” of the transmitting side wavelength λ3 of the node B as a start node. “1” is written in “GID” because the spare optical path of OID1 is shared and so the group identifier is “1”. That is, the nodes of the current optical path of OID3 are A-B which do not overlap B-C-D as the nodes of the current optical path of OID1. Hence, the spare optical path can be shared by OID1 and OID3.

The relay node allocation requesting process is performed in accordance with a flow chart shown in FIG. 18. In step 91, the optical path control unit 54 searches GIDs on the transmitting side of the optical path control table 58 for a value matching the GID described in the additional information of the optical path information. If there is a GID that matches, an existing spare optical path can be shared, so in step 92 the wavelength at which the GIDs match is selected as the optical path output wavelength. If no GID matches, it is necessary to form a new spare optical path, so in step 93 an unused wavelength is selected as the optical path output wavelength. In step 94, the optical path control unit 54 updates the optical path control table 58 on the basis of the above processing result. In step 95, the optical path control unit 54 describes the output wavelength selected by the above processing into the additional information of the optical path information, describes the NIP of its own node and the NIP, loaded from the route information, of a node adjacent in the end node direction, into SrcIP and DstIP, respectively, of the IP packet containing the optical path information, and transfers the updated optical path information to the adjacent node.

In the update of the optical path control table 58, “out” is written in “use state” and values received by the optical path information are written in “OID” and “GID” of the corresponding output wavelength. When the existing spare optical path is to be shared, values are already described in “use state”, “OID”, and “GID” of the corresponding output wavelength, so only necessary values need be added. Also, the wavelength described in the additional information of the optical path information before update is the input wavelength of an optical path. Therefore, on the basis of this input wavelength and the GID described in the optical path information, “in” is written in “use state” and values received by the optical path information are written in “OID” and “GID” of the corresponding wavelength in the optical path control table 58. When the existing spare optical path is to be shared, values are already described in “use state”, “OID”, and “GID” of the corresponding input wavelength, so only necessary values need be added. Accordingly, for the spare optical path of OID3, as shown in FIGS. 21A through 21E, “in” is written in “use state” of the receiving side wavelength λ3 and “out”, “3”, and “1” are respectively written in “use state”, “OID”, and “GID” of the transmitting side wavelength λ3 of the node C as a relay node. In addition, “in”, “3”, and “1” are respectively written in “use state”, “OID”, and “GID” of the receiving side wavelength λ3 of the node D as a relay node. For the transmitting side wavelength, “out” and “3” are respectively written in “use state” and “OID” of the wavelength λ1 at which the GIDs match. Furthermore, for the receiving side wavelength and transmitting side wavelength of the node E as a relay node, “3” is written in “OID” of the wavelength λ1 at which the GIDs match.

The end node allocation requesting process is performed in accordance with a flow chart shown in FIG. 19. In step 101, the optical path control unit 54 searches GIDs on the receiving side of the optical path control table 58 for a value matching the GID described in the additional information of the optical path information. If no GID matches, in step 102 the optical path control unit 54 instructs the optical switch unit 48 via the communication interface to allocate the wavelength described in the additional information of the optical path information as the optical path branching wavelength. On the basis of this instruction, the optical switch unit 48 allocates the optical path branching wavelength. If there is a GID that matches and if the processing in step 102 is completed, in step 103 the optical path control unit 54 updates the optical path control table 58. In step 104, the optical path control unit 54 describes allocation confirmation in the control ID of the optical path information, describes the NIP of its own node and the NIP, loaded from the route information, of a node adjacent in the start node direction, into SrcIP and DstIP, respectively, of the IP packet containing the optical path information, and transfers the updated optical path information to the adjacent node.

In the update of the optical path control table 58, “drop” is written in “use state” and values received by the optical path information are written in “OID” and “GID” of the corresponding branching wavelength. When the existing spare optical path is to be shared, values are already described in “use state”, “OID”, and “GID” of the corresponding branching wavelength, so only necessary values need be added. Accordingly, for the spare optical path of OID3, as shown in FIGS. 21A through 21E, “drop” and “3” are respectively written in “use state” and “OID” of the receiving side wavelength λ1 at which the GIDs match.

Upon receiving the optical path information having the allocation confirmation described in the control ID, the optical path control unit 54 refers to the route information. If determining in step 11 of FIG. 20 that this information corresponds to a relay node, in step 12 the optical path control unit 54 looks up the optical path control table 58 on the basis of the OID and GID described in the optical path information, and instructs the optical switch unit 48 via the communication interface to allocate an input wavelength and an output wavelength, respectively matching the OID and GID, as the optical path conversion wavelengths. On the basis of this instruction, the optical switch unit 48 allocates the optical path conversion wavelengths. In step 13, the optical path control unit 54 describes the NIP of its own node and the NIP, loaded from the route information, of a node adjacent in the start node direction, into SrcIP and DstIP, respectively, of the IP packet containing the optical path information, and transfers the optical path information to the adjacent node. If determining in step 11 that the information does not correspond to a relay node, in step 14 the optical path control unit 54 searches GIDs on the transmitting side of the optical path control table 58 for a value matching the GID described in the additional information of the optical path information. If no GID matches, in step 15 the optical path control unit 54 looks up the optical path control table 58 on the basis of the OID and GID described in the optical path information, and instructs the optical path switch unit 48 via the communication interface to allocate the wavelength at which the GIDs match as the optical path insertion wavelength. On the basis of this instruction, the optical switch unit 48 allocates the optical path insertion wavelength. If a GID that matches is found in step 14 and if the processing in step 15 is completed, in step 16 the optical path control unit 54 describes the NIP of its own node and the IP address of the optical path manager 10 into SrcIP and DstIP, respectively, of the IP packet containing the optical path information, and transfers the optical path information to the NMS 2.

Upon receiving the optical path information having the allocation confirmation described in the control ID, the optical path controller 20 updates the number of unused wavelengths owned by the WDM transmitter, contained in the configuration management table 22, on the basis of the OID and route information. Additionally, the optical path controller 20 writes information of the optical path allocated between the nodes into the optical path management table 24. If necessary, the optical path controller 20 notifies the request source that the optical path allocation is completed.

In the above explanation, the operation of allocating a new spare optical path by sharing an existing spare path is described. However, it is obviously also possible to similarly allocate a new spare optical path without sharing any current optical path and existing spare optical path, in accordance with the flow charts shown in FIGS. 16 through 20.

Also, the allocation of clockwise optical paths is described in the above explanation. However, it is evidently also possible to allocate counterclockwise optical paths in a similar fashion.

In the above explanation, the optical path insertion wavelength and conversion wavelengths are allocated to the optical switch unit 48 in the flow chart of FIG. 20. However, it is also possible to allocate the insertion wavelength to the optical switch unit 48 after steps 72 and 73 in FIG. 17, or allocate the conversion wavelengths to the optical switch unit 48 after steps 92 and 93 in FIG. 18. When this is the case, the relay node and start node of an optical path need only transfer optical path information having allocation confirmation described in the control ID, in accordance with step 13 or 16 in FIG. 20.

Note that the operations of the flow charts shown in FIGS. 16 through 20 are merely examples. Therefore, it is also possible to integrate a plurality of steps or to variously modify the configurations of the flow charts without departing from the gist of the present invention.

In the above explanation, the configuration management table 22 of the optical path manager 10 manages the number of unused wavelengths owned by the WDM transmitting unit 46 of the WDM transmitter. However, the number of unused wavelengths can also be managed by the optical path controller 16 of each node in accordance with the setting of an optical path. In this case, if no optical path can be allocated owing to the lack of wavelengths at nodes on the route, allocation inability is described in the control ID of optical path information. This optical path information is first transferred between adjacent nodes and then transferred from the nodes to the NMS 2. The NMS 2 notifies the request source that the allocation of the optical path is unsuccessful. Also, when receiving optical path information having allocation inability described in the control ID, the optical path control unit 54 of each node looks up the optical path control table 58 on the basis of the OID and GID to update the use state of the corresponding wavelength to “unused”.

(Operation Related to Release of Optical Path)

The release of a shared spare optical path will be described below by explaining in detail operation of releasing a clockwise spare optical path (OID1) set by setting request 1 while optical paths pertaining to setting requests 1 through 3 shown in FIGS. 9A through 9C are set.

To release an optical path allocated between nodes, as in the case of optical path allocation, the request source designates the route or OID of the optical path to the optical path controller 20. On the basis of the designated route or OID, the optical path controller 20 searches the optical path management table 24 and the optical path sharing table 26 for a corresponding optical path, thereby determining a route by which the optical path is released.

If an optical path to be released cannot be specified by searching the optical path management table 24 because no relay nodes are designated or only some relay nodes are designated, it is only necessary to instruct the request source to designate relay nodes required to specify the optical path to be released. If the release of an optical path is impossible because no corresponding optical path exists, the request source is notified of this information.

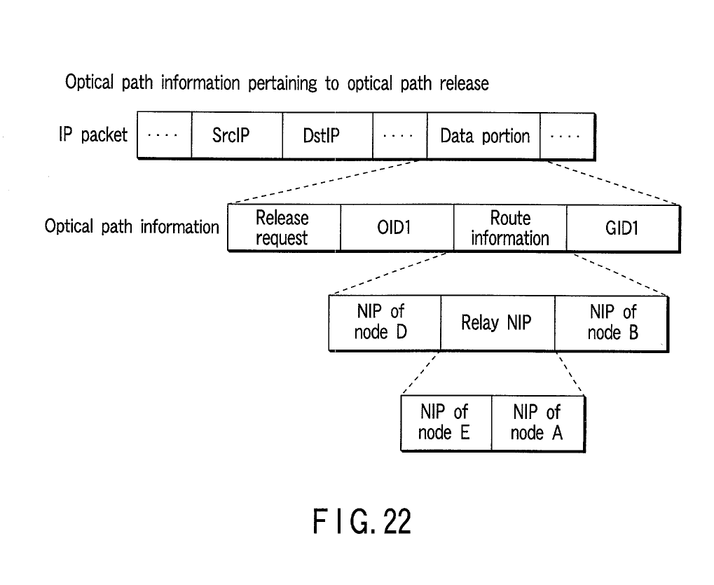

To release the spare optical path (OID1) set between the nodes D-E-A-B in accordance with setting request 1, the optical path controller 20 of the NMS 2 notifies the optical path controller 16 of the node D of the release of the optical path by transferring optical path information. FIG. 22 shows an example of the optical path information transferred from the NMS 2 to the node B. A release request, OID1, and GID1 obtained by the search of the optical path sharing table 26 are respectively described in the control ID, OID, and additional information. The NIP of the node D and the NIP of the node B are respectively described in the start NIP and end NIP of the route information. The NIPs of the nodes E and A are described in order, along the route of the spare optical path, into the relay NIP. The IP address of the optical path manager 10 and the IP address of the node D are respectively described in SrcIP and DstIP of an IP packet containing this optical path information. The optical path information is transferred from the NMS 2 to the node D by packet routing performed by the IP router.

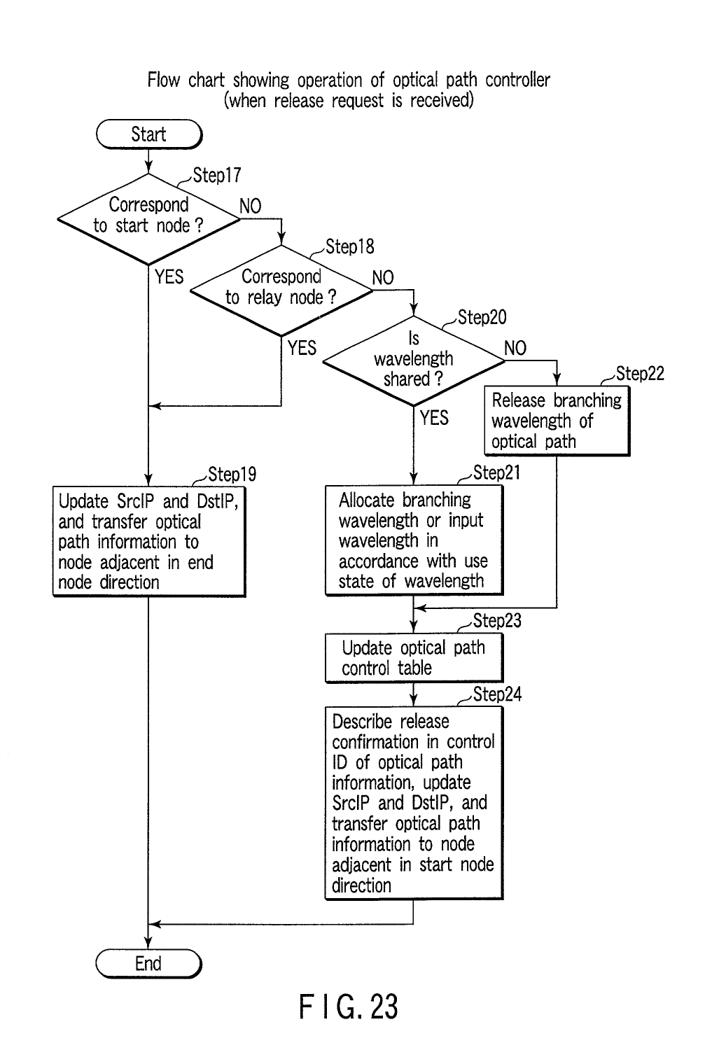

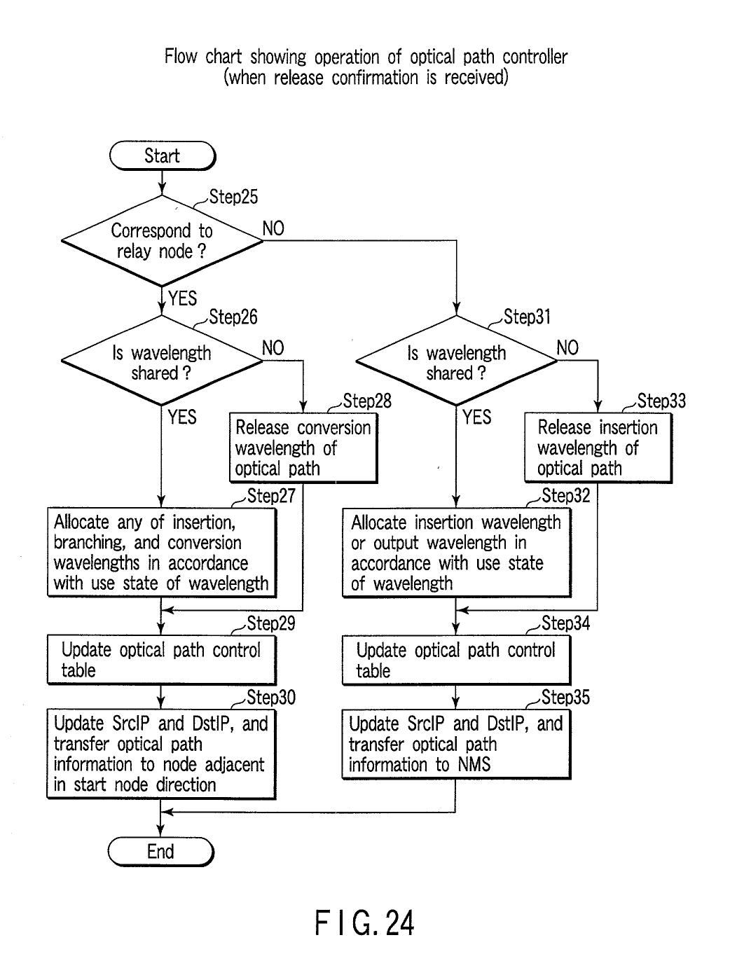

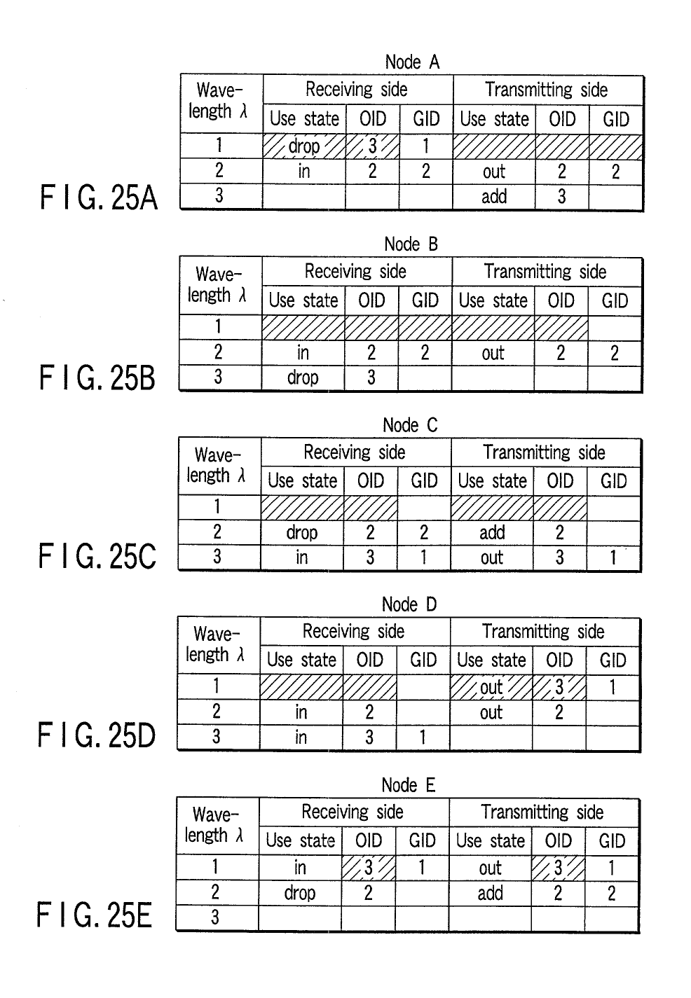

Upon receiving optical path information having a release request, release confirmation, or release inability described in the control ID via the communication interface, the optical path control unit 54 of each node performs processing pertaining to optical path release. FIG. 23 shows an example of a flow chart showing operation performed by the optical path control unit 54 when optical path information having a release request described in the control ID is received. FIG. 24 shows an example of a flow chart showing operation performed by the optical path control unit 54 when optical path information having release confirmation described in the control ID is received. FIGS. 25A through 25E illustrate examples of the states, immediately after the spare optical path (OID1) of setting request 1 is released, of the optical path control tables 58 of the individual nodes related to the clockwise ring.

In this embodiment of the present invention, a current optical path and a spare optical path are handled as a pair. Therefore, FIGS. 25A through 25E illustrate the states in which the current optical path (OID1) of setting request 1 is also released. In addition, portions updated from the optical path control tables 58 shown in FIGS. 21A through 21E are hatched in FIGS. 25A through 25E.

Upon receiving optical path information having a release request described in the control ID, the optical path control unit 54 refers to the route information. If determining in step 17 or 18 of FIG. 23 that the information corresponds to a start node or relay node, the optical path control unit 54 describes the NIP of its own node and the NIP, loaded from the route information, of a node adjacent in the end node direction, into SrcIP and DstIP, respectively, of the IP packet containing the optical path information, and transfers this optical path information to the adjacent node. If determining that the information does not correspond to either node, in step 20 the optical path control unit 54 searches the optical path control table 58 for a wavelength at which the OID and GID described in the optical path information match, and checks whether the corresponding wavelength is shared. If determining that the wavelength is shared, in step 21 the optical path control unit 54 instructs the optical switch unit 48 via the communication interface to allocate the corresponding wavelength to the branching wavelength or input wavelength of the optical path, in accordance with the use state described in the optical path sharing table 26. On the basis of this instruction, the optical switch unit 48 allocates the branching wavelength or input wavelength of the optical path. If determining that the wavelength is not shared, in step S22 the optical path control unit 54 instructs the optical switch unit 48 via the communication interface to release the corresponding wavelength from the branching wavelength of the optical path. On the basis of this instruction, the optical switch unit 48 releases the branching wavelength of the optical path. In step 23, the optical path control unit 54 updates the optical path control table 58 by releasing the use state (drop) and OID related to the branching wavelength of the optical path to be released. In step S24, the optical path control unit 54 updates the optical path information by describing release confirmation in the control ID, describes the NIP of its own node and the NIP, loaded from the route information, of a node adjacent in the start node direction, into SrcIP and DstIP, respectively, of the IP packet containing the optical path information, and transfers the updated optical path information to the adjacent node.

Note that in step 20, the optical path control unit 54 can determine that the corresponding wavelength is shared, if a plurality of data are described in “use state” or “OID” of the optical path control table 58. Accordingly, for the spare optical path of OID1, no plurality of data are described in “use state” and “OID” of the receiving side wavelength λ1 in the optical path control table 58 of the node B as an end node shown in FIGS. 21A through 21E. So, the optical path control unit 54 determines that this wavelength is not shared. Step 21 is the processing when the wavelength is shared: for the corresponding wavelength, a use state not matching the OID described in the optical path information is allocated to the optical switch unit 48. If the corresponding wavelength is shared, in step 23 it is only necessary to erase, from the optical path control table 58, the use state and the value of the OID described in the optical path information.

Upon receiving the optical path information having the release confirmation in the control ID, the optical path control unit 54 refers to the route information. In step 25 of FIG. 24, the optical path control unit 54 checks whether the information corresponds to a relay node. If determining that the information corresponds to a relay node, in step 26 the optical path control unit 54 checks, by the same processing as in step 20, that the wavelength is shared. If determining that the wavelength is shared, in step 27 the optical path control unit 54 instructs the optical switch unit 48 via the communication interface to allocate the corresponding wavelength to the insertion wavelength, branching wavelength, or conversion wavelength, in accordance with the use state described in the optical path control table 58. On the basis of this instruction, the optical switch unit 48 allocates the insertion wavelength, branching wavelength, or conversion wavelength of the optical path. If determining that the wavelength is not shared, in step 28 the optical path control unit 54 instructs the optical switch unit 28 via the communication interface to release the corresponding wavelength from the conversion wavelength of the optical path. On the basis of this instruction, the optical switch unit 48 releases the conversion wavelength of the optical path. In step 29, the optical path control unit 54 updates the optical path control table 58 by erasing the use states (“in” and “out”) and the OID pertaining to the conversion wavelength of the optical path to be released.

In step 30, the optical path control unit 54 describes the NIP of its own node and the NIP, loaded from the route information, of a node adjacent in the start node direction, into SrcIP and DstIP, respectively, of the IP packet containing the optical path information, and transfers the optical path information to the adjacent node. If determining in step 25 that the information does not correspond to a relay node, in step 31 the optical path control unit 54 checks, by the same processing as in step 20, that the wavelength is shared. If determining that the wavelength is shared, in step 32 the optical path control unit 54 instructs the optical path switch unit 48 via the communication interface to allocate the corresponding wavelength to the insertion wavelength or output wavelength, in accordance with the use state described in the optical path control table 58. On the basis of this instruction, the optical switch unit 48 allocates the insertion wavelength or output wavelength of the optical path. If determining that the wavelength is not shared, in step 33 the optical path control unit 54 instructs the optical switch unit 48 via the communication interface to release the corresponding wavelength from the insertion wavelength of the optical path. On the basis of this instruction, the optical switch unit 48 releases the insertion wavelength of the optical path. In step 34, the optical path control unit 54 updates the optical path control table 58 by erasing the use state (add) and the OID pertaining to the insertion wavelength of the optical path to be released. In step 35, the optical path control unit 54 describes the NIP of its own node and the IP address of the optical path manager 10 into SrcIP and DstIP, respectively, of the IP packet containing the optical path information, and transfers the optical path information to the NMS 2.

Note that in steps 26 and 31, it is determined that the corresponding wavelength is shared if a plurality of data are written in “use state” and “OID” of that wavelength in the optical path control table 58. For the spare optical path of OID1, therefore, a plurality of data are written in “use state” and “OID” of the receiving side wavelength λ1 in the optical path control table 58 of the node A as a relay node shown in FIGS. 21A to 21E, so it is determined that this wavelength is shared. Since no plurality of data are described for the transmitting side wavelength λ1, it is determined that this wavelength is not shared. Also, for the node E as a relay node, a plurality of data are described in “OID” of the receiving side wavelength λ1 and the transmitting side wavelength λ1, so it is determined that this wavelength is shared. Note also that steps 27 and 32 are processes when the wavelength is shared: it is only necessary to allocate, to the optical switch unit 48, the use state not matching the OID described in the optical path information, with respect to the corresponding wavelength. Accordingly, at the node A as a relay node, the receiving side wavelength λ1 is allocated as the branching wavelength to the optical switch unit 48. At the node E as another relay node, the receiving side wavelength λ1 and the transmitting side wavelength λ1 are respectively allocated as the input wavelength and the output wavelength to the optical switch unit 48. For this node E, however, this process can also be omitted because the use state of the corresponding wavelength remains unchanged. If the corresponding wavelength is shared in step 29, only the use state (“in” or “out”) and the value of the OID described in the optical path information need be erased from the optical path control table 58. If the corresponding wavelength is shared in step 34, only the use state (add) and the value of the OID described in the optical path information need be erased from the optical path control table 58.

Upon receiving the optical path information having the release confirmation in the control ID, the optical path controller 20 updates the number of unused wavelengths owned by the WDM transmitter, contained in the configuration management table 22, on the basis of the OID and the route information. The optical path controller 20 also erases, from the optical path management table 24, the information of the optical path released from between the nodes. If necessary, the optical path controller 20 informs the request source that the release of the optical path is completed.

In the above explanation, the operation of releasing a shared spare optical path is described. However, it is obviously also possible to similarly release a current optical path and an unshared spare optical path, in accordance with the flow charts shown in FIGS. 23 and 24.

Also, the release of clockwise optical paths is described in the above explanation. However, it is evidently also possible to release counterclockwise optical paths in a similar fashion.

In the above explanation, the optical path insertion wavelength and conversion wavelengths are released from the optical switch unit 48 in the flow chart of FIG. 24. However, it is also possible to perform the same processes as in steps 31 through 34 after it is determined in step 17 of FIG. 23 that the information corresponds to a start node, or to perform the same processes as in steps 26 through 29 after it is determined in step 18 of FIG. 23 that the information corresponds to a relay node. When this is the case, the relay node and start node of an optical path need only transfer optical path information having release confirmation described in the control ID, in accordance with step 30 or 35 in FIG. 24.

Note that the operations of the flow charts shown in FIGS. 23 and 24 are merely examples. Therefore, it is also possible to integrate a plurality of steps or variously modify the configurations of the flow charts without departing from the gist of the present invention.

In the above explanation, if a wavelength cannot be released for some reason when an optical path is released at a node, release inability is described in the control ID of optical path information. This optical path information is first transferred between adjacent nodes and then transferred from these nodes to the NMS 2. The NMS 2 notifies the request source that the release of the optical path is unsuccessful.

In this embodiment of the present invention, an optical path is set by using a start node as a start point. However, by using the method described in Japanese Patent Application No. 2000-395299, it is also possible to set an optical path by using an end node as a start point, using a relay node as a start point, or using start and end nodes as start points. In this case, it is only necessary to appropriately change the flow charts shown in FIGS. 16 through 20 for optical path allocation, and the flow charts shown in FIGS. 23 and 24 for optical path release. That is, the method of setting an optical path between nodes can be variously modified.

Note that in this embodiment of the present invention, the optical switch unit 48 is also set when a spare optical path is set. However, it is also possible to perform only the process of describing the configuration of a spare optical path into the optical path control table 58, without setting the optical switch unit 48 when an optical path is set. When this is the case, in recovery operation to be described in the second embodiment, the setting, related to a spare optical path, of the optical switch unit 48 need only be performed on the basis of the optical path control table 58.

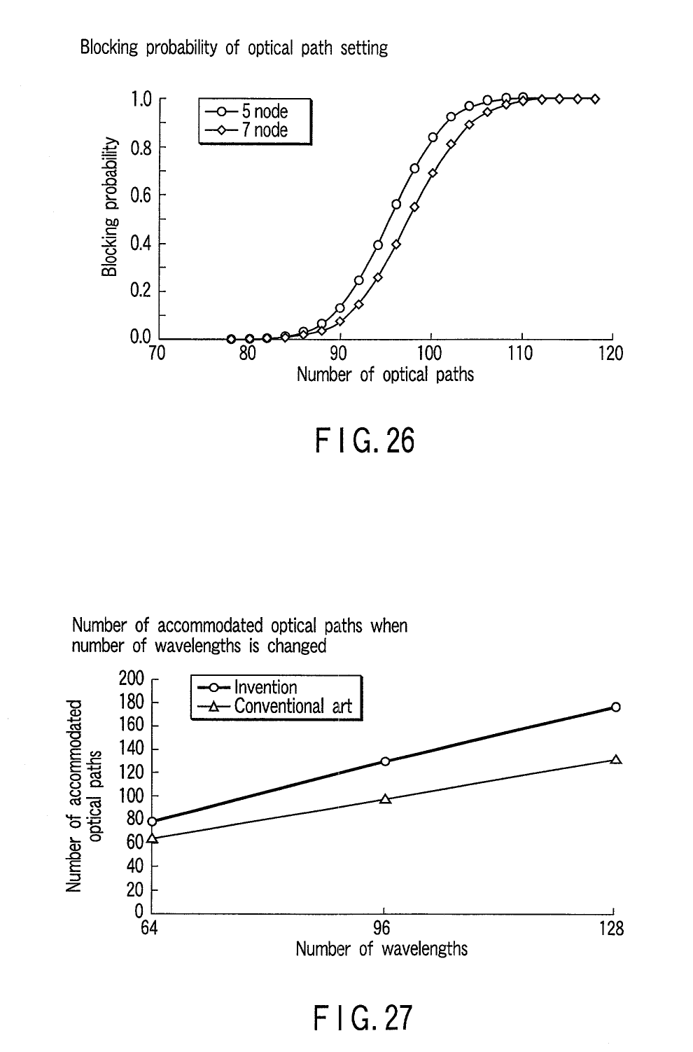

FIG. 26 shows the results of calculations of blocking (wavelengths become insufficient to make optical path allocation impossible) probability by computer simulation, when optical paths are dynamically allocated on the basis of the present invention between two nodes constituting the WDM ring system. Referring to FIG. 26, a blocking probability of 0.0 indicates that the ratio of success in setting paths is 100%, and a blocking probability of 1.0 indicates that the ratio of failure in setting paths is 100%. In this simulation, the number of wavelengths of a one-way (clockwise or counterclockwise) ring was set to 64, nodes for setting a current optical path were randomly determined in accordance with a uniform distribution, and a current optical path was allocated by the shortest route. From the simulation results, compared to the number (64) of optical paths capable of being accommodated by the conventional method in which spare optical paths are not shared, a large number (78) of optical paths can be accommodated by this method before blocking occurs. Also, the optical path accommodation efficiency can improve by a maximum of about 1.7 times when the number of nodes is 5, and by a maximum of about 1.8 times when it is 7. This demonstrates that the present invention, in which a spare optical path is shared by a plurality of current optical paths having different routes, can increase the optical path accommodation efficiency compared to the conventional method. Also, the optical path accommodation efficiency improves more when the number of nodes is 7 than when it is 5. When the number of nodes increases to upscale the system, therefore, the optical path accommodation efficiency can be increased more. So, the present invention can implement an economical WDM ring network system.

FIG. 27 shows the numbers of optical paths capable of being accommodated until blocking occurs, obtained by similar computer simulation in which the number of wavelengths of a one-way (clockwise or counterclockwise) ring is changed in the 7-node WDM ring network system. The simulation results indicate that the optical path accommodation efficiency improves as the number of wavelengths increases. Accordingly, when the number of nodes increases to upscale the system, the optical path accommodation efficiency can be increased more. So, the present invention can implement an economical WDM ring network system.

(Second Embodiment)

Another embodiment of the apparatus according to the present invention will be described below. In the explanation of the other embodiment, the same reference numerals as in the first embodiment denote the same parts, and a detailed description thereof will be omitted.

In the second embodiment according to the present invention, recovery operation will be explained which is performed using a spare optical path allocated between nodes when an optical transmission line connecting nodes is broken or when a communication trouble occurs by, e.g., a failure of a node.

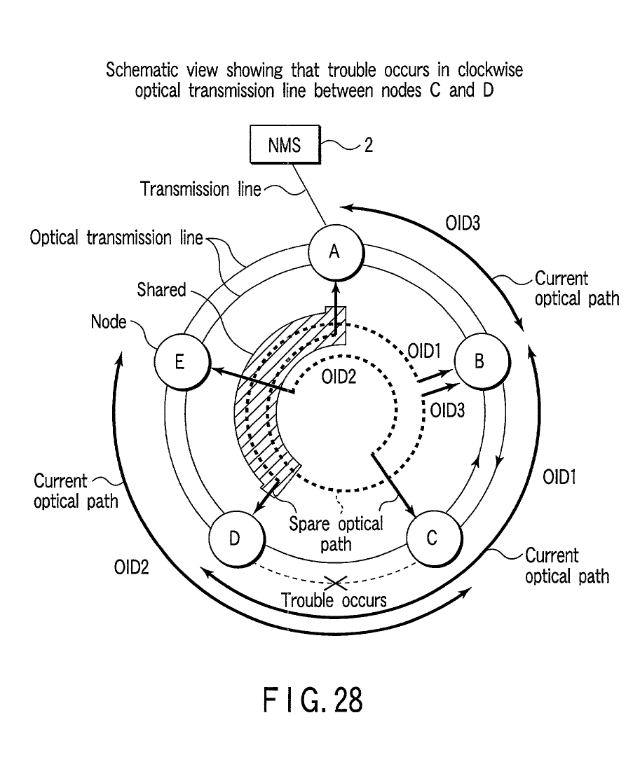

FIG. 28 shows a case example in which a clockwise optical fiber connecting nodes C and D is broken when optical paths are already allocated between nodes by setting requests 1 through 3 shown in FIGS. 9A through 9C. The optical fiber having the trouble is indicated by the broken line. When the reception of optical signals is interfered with by the occurrence of a trouble, a node detects a LOPS (Loss of Optical Path Signal). In the example shown in FIG. 28, therefore, the node D detects a LOPS related to a current optical path of OID1, and a node E detects a LOPS related to a current optical path of OID2. In the following explanation, operation of recovery from a trouble concerning the optical path of OID1 will be described in detail.

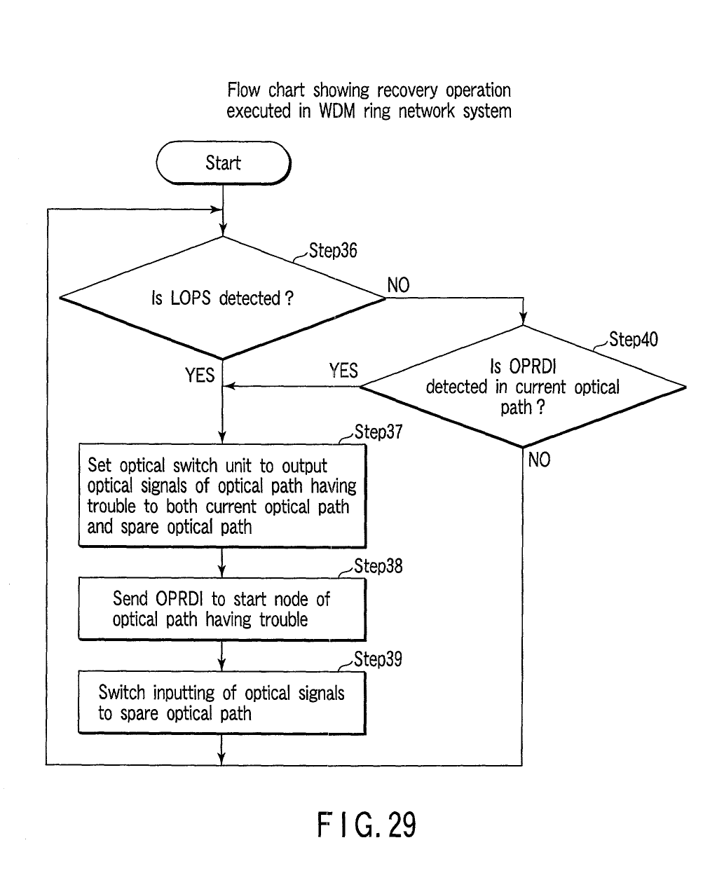

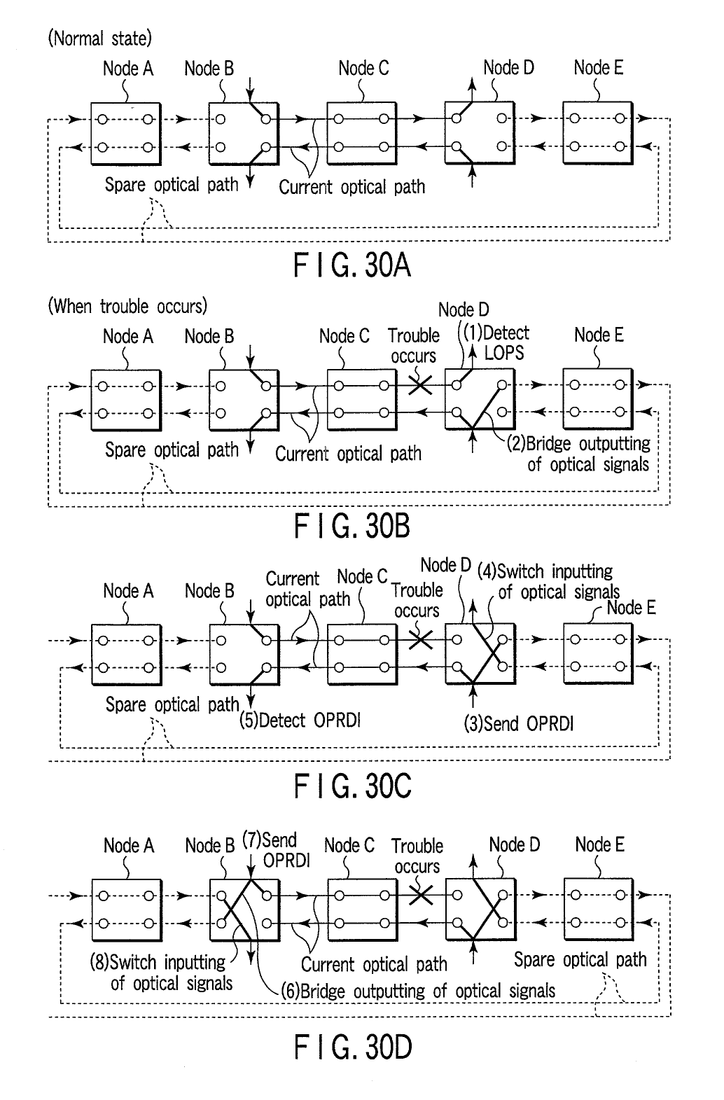

FIG. 29 is an example of a flow chart showing the recovery operation executed in a WDM ring network system when a trouble occurs. FIGS. 30A through 30D illustrate an example of the operation of recovery from a trouble concerning the optical path of OID1. In a normal state, a current optical path allocated in two ways exchanges optical signals between a node B and the node D. If a clockwise optical fiber connecting the nodes C and D is broken, in step 36 a WDM transmitting unit 46 of the node D detects a LOPS and transfers this LOPS and information of the corresponding wavelength to an optical path control unit 54 (\hat{1} in FIG. 30B). Upon receiving the LOPS, the optical path control unit 54 looks up an optical path control table 58. In step 37, the optical path control unit 54 sets an optical switch unit 48 to output optical signals, which have been output through the corresponding optical path, to both a current optical path and a spare optical path (\hat{2} in FIG. 30B). In step 38, the optical path control unit 54 sends an OPRDI (Optical Path Remote Defect Indication) to the start node of the optical path having the trouble (\hat{3} in FIG. 30C). In step 39, the optical path control unit 54 switches inputting of optical signals to the spare optical path (\hat{4} in FIG. 30C). Since the node D sends the OPRDI, in step 40 a WDM transmitting unit 46 of the node B looks up an optical path control table 58 to check whether an OPRDI is detected in the current optical path. In this case, the OPRDI is detected in the current optical path (OID1), so the WDM transmitting unit 46 transfers this OPRDI and information of the corresponding wavelength to an optical path control unit 54 (\hat{5} in FIG. 30C). Upon receiving the OPRDI, the optical path control unit 54 looks up an optical path control table 58 and performs the same processes as in steps 37 through 40 (\hat{6} through \hat{8} in FIG. 30D). By the above processing, the optical path recovery operation in the WDM ring network system is completed.

Note that a LOPS can also be detected by deterioration of a bit error rate by monitoring the bit error rate of an optical signal by the WDM transmitting unit 46. Note also that the WDM transmitting unit 46 can send an OPRDI by describing it in the header of a frame for transmitting an optical signal. Furthermore, if an OPRDI is detected in step 40, inputting of optical signals can also be continued using the current optical path by omitting the process of sending an OPRDI in step 38 or by omitting the process of switching inputting of optical signals in step 39.

The flow chart shown in FIG. 29 is merely an example of the operation. Therefore, it is also possible to integrate a plurality of steps or variously modify the configuration of the flow chart without departing from the gist of the present invention. For example, steps 37 and 38 can be switched: after an OPRDI is sent to the start node of an optical path having a trouble, the optical switch unit 48 can be set to output optical signals, which have been output through the corresponding optical path, to both a current optical path and a spare optical path. It is evident that the recovery operation can be performed even in a case like this.

When a portion having a trouble is completely restored, a process of returning the normal state need only be performed such that optical signals are exchanged between nodes by using current optical paths. In the above explanation, the operation of recovery from a trouble pertaining to the optical path of OID1 is described. However, recovery related to the optical path of OID2 is evidently similarly performable.

In the above explanation, a trouble occurs because a one-way optical fiber connecting nodes is broken. However, even when two-way optical fibers connecting nodes are broken, recovery can be similarly performed in accordance with the flow chart shown in FIG. 29. In the following explanation, recovery operation when clockwise and counterclockwise optical fibers connecting the nodes C and D are broken will be described.

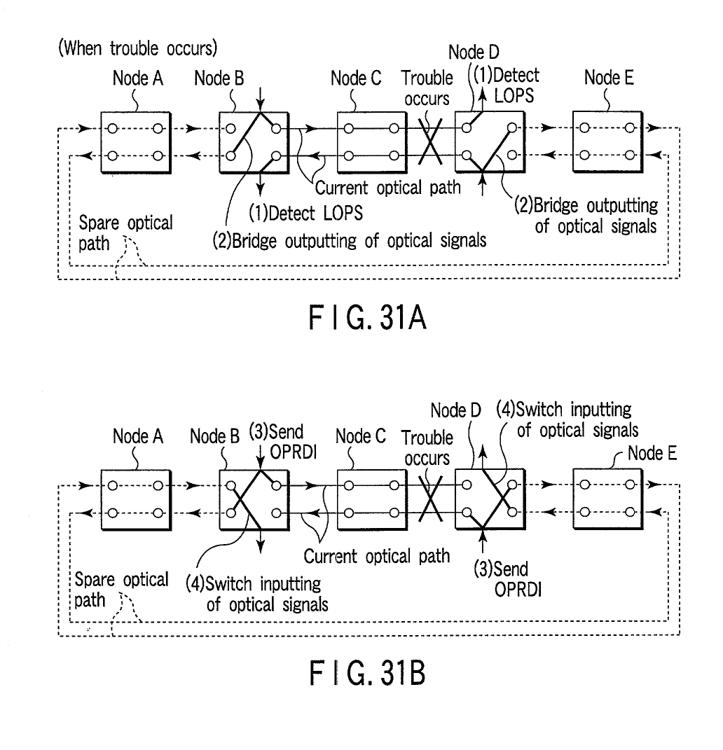

FIGS. 31A and 31B illustrate an example of the operation of recovery from a trouble concerning the optical path of OID1, when two-way optical fibers connecting the nodes C and D are broken. In a normal state, similar to the state shown in FIGS. 30A through 30D, optical signals are exchanged between the nodes B and D by a current optical path allocated in two ways. When a trouble occurs by the breakage of the optical path, the WDM transmitting unit 46 of each of the nodes B and D detects a LOPS and transfers this LOPS and information of the corresponding wavelength to the optical path control table 58, in step 36 of the flow chart shown in FIG. 29 (\hat{1} in FIG. 31A). Upon receiving the LOPS, the optical path control unit 54 performs the processes in steps 37 through 39 in the same manner as described above (\hat{2} through \hat{4} in FIGS. 31A and 31B). By the above processing, the optical path recovery operation in the WDM ring network system is completed.

In the recovery operation of the WDM ring network system based on the present invention, no messages need be notified between the terminal nodes of optical paths when a current optical path is switched to a spare optical path. Accordingly, recovery can be performed by an extremely simple operation. Compared to the conventional system, therefore, no message relay process is necessary at nodes on the route of a spare optical path, so no processing need be performed at nodes irrelevant to the trouble when a current optical path is switched to the spare optical path. Consequently, recovery operation when a trouble occurs can be performed at high speed. Even when the system is upscaled by increasing the number of nodes or the number of wavelengths, a highly reliable WDM ring network system can be implemented. Also, in the present invention a spare optical path is shared by a plurality of current optical paths having different routes. Therefore, recovery is possible because a shared spare optical path is not used by two or more current optical paths at the same time, except in the case of multiple trouble such as when optical fibers are broken in a plurality of zones connecting nodes or when troubles occur at a plurality of nodes.

In the above embodiments, the number of optical fibers is 2. However, the present invention is not limited to the above embodiments and applicable to at least two or more fibers.

Additional advantages and modifications will readily occur to those skilled in the art. Therefore, the invention in its broader aspects is not limited to the specific details and representative embodiments shown and described herein. Accordingly, various modifications may be made without departing from the spirit and scope of the general inventive concept as defined by the appended claims and their equivalents.

What is claimed is:

1. A wavelength division multiplexing ring network system which comprises an optical transmission line including at least a clockwise optical transmission line and a counterclockwise optical transmission line, and a plurality of nodes connected into the form of a ring via said transmission line to transmit and receive a plurality of optical signals having different wavelengths, terminate optical paths, and switch connections of said optical paths, and in which an optical path having an arbitrary wavelength is set by which an optical signal transmitted from an arbitrary start node through an arbitrary optical fiber is received by an arbitrary end node, comprising:
means for setting a current optical path on a route via said clockwise or counterclockwise optical transmission line extending from said start node to said end node, and setting a spare optical path on a route reverse to said current optical path extending from said start node to said end node;
means for sharing said spare optical path among said current optical paths having different routes;
means for, when a node which terminates said current optical path detects a trouble pertaining to reception of an optical signal, outputting an optical signal to both said current optical path and said spare optical path, sending an alarm signal to an opposite node of said current optical path having the trouble, and switching inputting of optical signals to said spare optical path; and
means for, when a node which terminates said current optical path detects the alarm signal, outputting an optical signal to both said current optical path and said spare optical path, and switching inputting of optical signals to said spare optical path.

2. A node of a wavelength division multiplexing ring network system which comprises an optical transmission line including at least a clockwise optical transmission line and a counterclockwise optical transmission line, and a plurality of nodes connected into the form of a ring via said transmission line to transmit and receive a plurality of optical signals having different wavelengths, terminate optical paths, and switch connections of said optical paths, and in which an optical path having an arbitrary wavelength is set by which an optical signal transmitted from an arbitrary start node through an arbitrary optical fiber is received by an arbitrary end node, comprising:
means for setting a current optical path on a route via said clockwise or counterclockwise optical transmission line extending from said start node to said end node, and setting a spare optical path on a route reverse to said current optical path extending from said start node to said end node;
means for sharing said spare optical path among said current optical paths having different routes;
means for, when a node which terminates said current optical path detects a trouble pertaining to reception of an optical signal, outputting an optical signal to both said current optical path and said spare optical path, sending an alarm signal to an opposite node of said current optical path having the trouble, and switching inputting of optical signals to said spare optical path; and
means for, when a node which terminates said current optical path detects the alarm signal, outputting an optical signal to both said current optical path and said spare optical path, and switching inputting of optical signals to said spare optical path.

3. A wavelength division multiplexing ring network system which comprises an optical transmission line including at least a clockwise optical transmission line and a counterclockwise optical transmission line, and a plurality of nodes connected into the form of a ring via said transmission line to transmit and receive a plurality of optical signals having different wavelengths, terminate optical paths, and switch connections of said optical paths, and in which an optical path having an arbitrary wavelength is set by which an optical signal transmitted from an arbitrary start node through an arbitrary optical fiber is received by an arbitrary end node, comprising:
means for setting a current optical path on a route via said clockwise or counterclockwise optical transmission line extending from said start node to said end node, and setting a spare optical path on a route reverse to said current optical path extending from said start node to said end node; and
means for sharing said spare optical path among said current optical paths having different routes.

4. A system according to claim 3, further comprising means for setting said current optical path between nodes by a shortest route.

5. A system according to claim 3, further comprising means for setting said current optical path and said spare optical path in two ways between nodes.

6. A wavelength division multiplexing ring network system which comprises an optical transmission line including at least a clockwise optical transmission line and a counterclockwise optical transmission line, and a plurality of nodes connected into the form of a ring via said transmission line to transmit and receive a plurality of optical signals having different wavelengths, terminate optical paths, and switch connections of said optical paths, and in which an optical path having an arbitrary wavelength is set by which an optical signal transmitted from an arbitrary start node through an arbitrary optical fiber is received by an arbitrary end node, comprising:
means for setting a current optical path on a route via said clockwise or counterclockwise optical transmission line extending from said start node to said end node, and setting a spare optical path on a route reverse to said current optical path extending from said start node to said end node;
means for sharing said spare optical path among said current optical paths having different routes, and, when a node which terminates said current optical path detects a trouble pertaining to reception of an optical signal, outputting an optical signal to both said current optical path and said spare optical path, sending an alarm signal to an opposite node of said current optical path having the trouble, and switching inputting of optical signals to said spare optical path; and
means for, when a node which terminates said current optical path detects the alarm signal, outputting an optical signal to both said current optical path and said spare optical path, and switching inputting of optical signals to said spare optical path.

7. A wavelength division multiplexing ring network system which comprises a plurality of nodes for transmitting and receiving a plurality of optical signals having different wavelengths, terminating optical paths, and switching connections of said optical paths, and a network manager connected to at least one node, and in which said nodes are connected into the form of a ring via at least a clockwise optical transmission line and a counterclockwise optical transmission line, and an optical path having an arbitrary wavelength is set by which an optical signal transmitted from an arbitrary start node through an arbitrary optical fiber is received by an arbitrary end node, comprising:
means for setting a current optical path on a route via said clockwise or counterclockwise optical transmission line extending from said start node to said end node, and setting a spare optical path on a route reverse to said current optical path extending from said start node to said end node,
said network manager including optical path requesting means for requesting at least one node forming an optical path to set an optical path;
said node including optical path setting means for setting an optical path between nodes forming an optical path on the basis of the request from said network manager;
said optical path requesting means including means for checking whether an optical path can be set, means for determining a node to be requested to set an optical path, and means for checking whether said spare optical path can be shared,
said optical path setting means including means for setting an insertion wavelength of an optical path, means for setting a conversion wavelength of an optical path, and means for setting a branching wavelength of an optical path,
said means for checking whether said spare optical path can be shared including means for determining that said spare optical path can be shared when routes of said current optical paths set between nodes do not overlap, and requesting at least one node to set an optical path so as to form a new spare optical path by sharing an existing spare optical path, and
said optical path setting means including means for forming a new spare optical path by sharing a wavelength used by an existing spare optical path, when requested by said network manager to form the new spare optical path by sharing the existing spare optical path.

8. An optical path setting method in a wavelength division multiplexing ring network system which comprises an optical transmission line including at least a clockwise optical transmission line and a counterclockwise optical transmission line, and a plurality of nodes connected into the form of a ring via the transmission line to transmit and receive a plurality of optical signals having different wavelengths, terminate optical paths, and switch connections of the optical paths, and in which an optical path having an arbitrary wavelength is set by which an optical signal transmitted from an arbitrary start node through an arbitrary optical fiber is received by an arbitrary end node, comprising:
setting a current optical path on a route via the clockwise or counterclockwise optical transmission line extending from the start node to the end node, and setting a spare optical path on a route reverse to the current optical path extending from the start node to the end node;
sharing the spare optical path among the current optical paths having different routes;
when a node which terminates the current optical path detects a trouble pertaining to reception of an optical signal, outputting an optical signal to both the current optical path and the spare optical path, sending an alarm signal to an opposite node of the current optical path having the trouble, and switching inputting of optical signals to the spare optical path; and
when a node which terminates the current optical path detects the alarm signal, outputting an optical signal to both the current optical path and the spare optical path, and switching inputting of optical signals to the spare optical path.

9. An optical path setting method in a wavelength division multiplexing ring network system which comprises a plurality of nodes for transmitting and receiving a plurality of optical signals having different wavelengths, terminating optical paths, and switching connections of the optical paths, and a network manager connected to at least one node, and in which the nodes are connected into the form of a ring via at least a clockwise optical transmission line and a counterclockwise optical transmission line, and an optical path having an arbitrary wavelength is set by which an optical signal transmitted from an arbitrary start node through an arbitrary optical fiber is received by an arbitrary end node, comprising the steps of:
setting a current optical path on a route via the clockwise or counterclockwise optical transmission line extending from the start node to the end node, and setting a spare optical path on a route reverse to the current optical path extending from the start node to the end node;
causing the network manager to request at least one node forming an optical path to set an optical path;
causing the node to set an optical path between nodes forming an optical path on the basis of the request from the network manager;
causing optical path requesting means to check whether an optical path can be set, determine a node to be requested to set an optical path, and check whether the spare optical path can be shared;
causing optical path setting means to set an insertion wavelength of an optical path, set a conversion wavelength of an optical path, and set a branching wavelength of an optical path;
causing means for checking whether the spare optical path can be shared to determine that the spare optical path can be shared when routes of the current optical paths set between nodes do not overlap, and request at least one node to set an optical path so as to form a new spare optical path by sharing an existing spare optical path; and
causing optical path setting means to form a new spare optical path by sharing a wavelength used by an existing spare optical path, when requested by the network manager to form the new spare optical path by sharing the existing spare optical path.

10. An optical path setting method in a wavelength division multiplexing ring network system which comprises an optical transmission line including at least a clockwise optical transmission line and a counterclockwise optical transmission line, and a plurality of nodes connected into the form of a ring via the transmission line to transmit and receive a plurality of optical signals having different wavelengths, terminate optical paths, and switch connections of the optical paths, and in which an optical path having an arbitrary wavelength is set by which an optical signal transmitted from an arbitrary start node through an arbitrary optical fiber is received by an arbitrary end node, comprising:
setting a current optical path on a route via the clockwise or counterclockwise optical transmission line extending from the start node to the end node, and setting a spare optical path on a route reverse to the current optical path extending from the start node to the end node; and
sharing the spare optical path among the current optical paths having different routes.

11. A method according to claim 10, wherein the current optical path is set between nodes by a shortest route.

12. A method according to claim 10, wherein the current optical path and the spare optical path are set in two ways between nodes.

13. A recovery method in a wavelength division multiplexing ring network system which comprises an optical transmission line including at least a clockwise optical transmission line and a counterclockwise optical transmission line, and a plurality of nodes connected into the form of a ring via the transmission line to transmit and receive a plurality of optical signals having different wavelengths, terminate optical paths, and switch connections of the optical paths, and in which an optical path having an arbitrary wavelength is set by which an optical signal transmitted from an arbitrary start node through an arbitrary optical fiber is received by an arbitrary end node, comprising:
setting a current optical path on a route via the clockwise or counterclockwise optical transmission line extending from the start node to the end node, and setting a spare optical path on a route reverse to the current optical path extending from the start node to the end node;
sharing the spare optical path among the current optical paths having different routes;
when a node which terminates the current optical path detects a trouble pertaining to reception of an optical signal, outputting an optical signal to both the current optical path and the spare optical path, sending an alarm signal to an opposite node of the current optical path having the trouble, and switching inputting of optical signals to the spare optical path; and
when a node which terminates the current optical path detects the alarm signal, outputting an optical signal to both the current optical path and the spare optical path, and switching inputting of optical signals to the spare optical path.

14. A program for setting an optical path in a wavelength division multiplexing ring network system which comprises an optical transmission line including at least a clockwise optical transmission line and a counterclockwise optical transmission line, and a plurality of nodes connected into the form of a ring via said transmission line to transmit and receive a plurality of optical signals having different wavelengths, terminate optical paths, and switch connections of said optical paths, and in which an optical path having an arbitrary wavelength is set by which an optical signal transmitted from an arbitrary start node through an arbitrary optical fiber is received by an arbitrary end node, said program causing a computer to execute the procedures of:
setting a current optical path on a route via said clockwise or counterclockwise optical transmission line extending from said start node to said end node, and setting a spare optical path on a route reverse to said current optical path extending from said start node to said end node;
sharing said spare optical path among said current optical paths having different routes;
when a node which terminates said current optical path detects a trouble pertaining to reception of an optical signal, outputting an optical signal to both said current optical path and said spare optical path, sending an alarm signal to an opposite node of said current optical path having the trouble, and switching inputting of optical signals to said spare optical path; and
when a node which terminates said current optical path detects the alarm signal, outputting an optical signal to both said current optical path and said spare optical path, and switching inputting of optical signals to said spare optical path.

15. A program for setting an optical path in wavelength division multiplexing ring network system which comprises a plurality of nodes for transmitting and receiving a plurality of optical signals having different wavelengths, terminating optical paths, and switching connections of said optical paths, and a network manager connected to at least one node, and in which said nodes are connected into the form of a ring via at least a clockwise optical transmission line and a counterclockwise optical transmission line, and an optical path having an arbitrary wavelength is set by which an optical signal transmitted from an arbitrary start node through an arbitrary optical fiber is received by an arbitrary end node, said program causing a computer to execute the procedures of:
setting a current optical path on a route via said clockwise or counterclockwise optical transmission line extending from said start node to said end node, and setting a spare optical path on a route reverse to said current optical path extending from said start node to said end node;
causing said network manager to request at least one node forming an optical path to set an optical path;
causing said node to set an optical path between nodes forming an optical path on the basis of the request from said network manager;
causing optical path requesting means to check whether an optical path can be set, determine a node to be requested to set an optical path, and check whether said spare optical path can be shared;
causing optical path setting means to set an insertion wavelength of an optical path, set a conversion wavelength of an optical path, and set a branching wavelength of an optical path;
causing means for checking whether said spare optical path can be shared to determine that said spare optical path can be shared when routes of said current optical paths set between nodes do not overlap, and request at least one node to set an optical path so as to form a new spare optical path by sharing an existing spare optical path; and
causing optical path setting means to form a new spare optical path by sharing a wavelength used by an existing spare optical path, when requested by said network manager to form the new spare optical path by sharing the existing spare optical path.

16. A program for setting an optical path in a wavelength division multiplexing ring network system which comprises an optical transmission line including at least a clockwise optical transmission line and a counterclockwise optical transmission line, and a plurality of nodes connected into the form of a ring via said transmission line to transmit and receive a plurality of optical signals having different wavelengths, terminate optical paths, and switch connections of said optical paths, and in which an optical path having an arbitrary wavelength is set by which an optical signal transmitted from an arbitrary start node through an arbitrary optical fiber is received by an arbitrary end node, said program causing a computer to execute the procedures of:
setting a current optical path on a route via said clockwise or counterclockwise optical transmission line extending from said start node to said end node, and setting a spare optical path on a route reverse to said current optical path extending from said start node to said end node; and
sharing said spare optical path among said current optical paths having different routes.

17. A program according to claim 14, further comprising a program for causing said computer to execute the procedure of setting said current optical path between nodes by a shortest route.

18. A method according to claim 16, further comprising a program for causing said computer to execute the procedure of setting said current optical path and said spare optical path in two ways between nodes.

19. A program for realizing a recovery method in a wavelength division multiplexing ring network system which comprises an optical transmission line including at least a clockwise optical transmission line and a counterclockwise optical transmission line, and a plurality of nodes connected into the form of a ring via said transmission line to transmit and receive a plurality of optical signals having different wavelengths, terminate optical paths, and switch connections of said optical paths, and in which an optical path having an arbitrary wavelength is set by which an optical signal transmitted from an arbitrary start node through an arbitrary optical fiber is received by an arbitrary end node, said program causing a computer to execute the procedures of:
setting a current optical path on a route via said clockwise or counterclockwise optical transmission line extending from said start node to said end node, and setting a spare optical path on a route reverse to said current optical path extending from said start node to said end node;
sharing said spare optical path among said current optical paths having different routes;
when a node which terminates said current optical path detects a trouble pertaining to reception of an optical signal, outputting an optical signal to both said current optical path and said spare optical path, sending an alarm signal to an opposite node of said current optical path having the trouble, and switching inputting of optical signals to said spare optical path; and
when a node which terminates said current optical path detects the alarm signal, outputting an optical signal to both said current optical path and said spare optical path, and switching inputting of optical signals to said spare optical path.
